(19) United States
(12) Patent Application Publication
(10) Pub. No.: US 2023/0260184 A1
(43) Pub. Date: Aug. 17, 2023

(54) FACIAL EXPRESSION IDENTIFICATION AND RETARGETING TO AN AVATAR

(71) Applicant: Zoom Video Communications, Inc., San Jose, CA (US)

(72) Inventors: Wenyu Chen, Singapore (SG); Chichen Fu, San Jose, CA (US); Qiang Li, Hangzhou (CN); Wenchong Lin, Hangzhou (CN); Bo Ling, San Jose, CA (US); Gengdai Liu, Singapore (SG)

(21) Appl. No.: 17/697,921

(22) Filed: Mar. 17, 2022

(30) Foreign Application Priority Data
Feb. 17, 2022 (CN) 202220325368.5

(51) Int. Cl. G06T 13/40; G06V 40/16; G06T 17/20; G06V 10/774; H04L 65/403

(52) U.S. Cl. CPC G06T 13/40; G06T 17/205; G06V 10/774; G06V 40/176; H04L 65/403

(57) ABSTRACT

Methods, systems, and apparatus, including computer programs encoded on computer storage media relate to a method for training machine learning network to generate facial expression for rendering an avatar within a video communication platform representing a video conference participant. Video images may be processed by the machine learning network to generate facial expression values. The generated facial expression values may be modified or adjusted to change the facial expression values. The modified or adjusted facial expression values may then be used to render a digital representation of the video conference participant in the form of an avatar.

### CROSS-REFERENCE TO RELATED APPLICATIONS

This application is a non-provisional application, and claims the benefit of Chinese application number CN202220325368.5, filed Feb. 17, 2022, which is hereby incorporated by reference in its entirety.

### FIELD

This application relates generally to avatar generation, and more particularly, to systems and methods for avatar generation using a trained neural network for automatic human face tracking and expression retargeting to an avatar in a video communications platform.

### SUMMARY

The appended claims may serve as a summary of this application.

### BRIEF DESCRIPTION OF THE DRAWINGS

FIG. 1A is a diagram illustrating an exemplary environment in which some embodiments may operate.

FIG. 1B is a diagram illustrating an exemplary computer system with software and/or hardware modules that may execute some of the functionality described herein.

FIG. 2 is a diagram illustrating an exemplary environment in which some embodiments may operate.

FIG. 3 is a flow chart illustrating an exemplary method that may be performed in some embodiments.

FIG. 4 is a flow chart illustrating an exemplary method that may be performed in some embodiments.

FIG. 5 is a diagram illustrating an exemplary process flow that may be performed in some embodiments.

FIGS. 6A-6K are diagrams illustrating exemplary equations referenced throughout the specification.

FIG. 7 is a flow chart illustrating and exemplary method for 3DMM parameter optimization based on 2D landmarks.

FIG. 8 is a diagram illustrating the use of neutral landmarks for pose optimization.

FIG. 9 is a diagram illustrating adaptive distance constraints for closed eye expressions.

FIGS. 10A and 10B are a diagrams illustrating example plots of variables for mouth or eye expression adjustments.

FIGS. 11A and 11B are diagrams illustrating an example avatar rendering results with and without modified distance constraints being applied.

FIGS. 12A - 12C are diagrams illustrating examples of three different customizations for expression retargeting.

FIG. 13 is a diagram illustrating an exemplary computer that may perform processing in some embodiments.

### DETAILED DESCRIPTION OF THE DRAWINGS

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

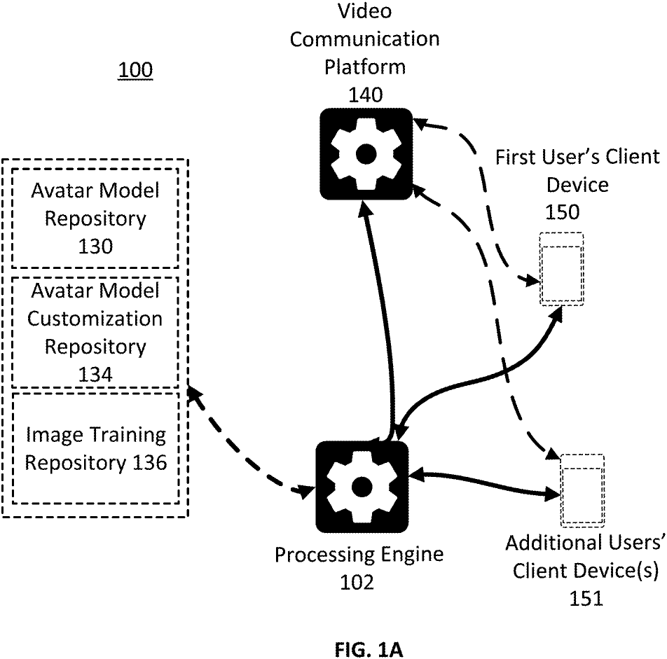

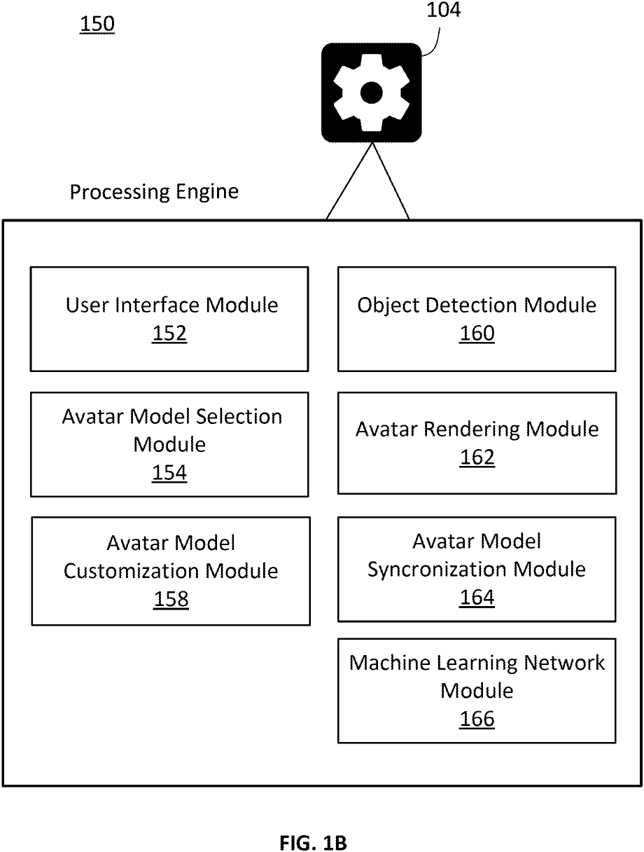

FIG. 1A is a diagram illustrating an exemplary environment in which some embodiments may operate. In the exemplary environment 100, a first user’s client device 150 and one or more additional users’ client device(s) 151 are connected to a processing engine 102 and, optionally, a video communication platform 140. The processing engine 102 is connected to the video communication platform 140, and optionally connected to one or more repositories (e.g., non-transitory data storage) and/or databases, including an avatar model repository 130, virtual background repository 132, an avatar model customization repository 134 and/or an image training repository for training a machine learning network. One or more of the databases may be combined or split into multiple databases. The first user’s client device 150 and additional users’ client device(s) 151 in this environment may be computers, and the video communication platform server 140 and processing engine 102 may be applications or software hosted on a computer or multiple computers which are communicatively coupled via remote server or locally.

The exemplary environment 100 is illustrated with only one additional user’s client device, one processing engine, and one video communication platform, though in practice there may be more or fewer additional users’ client devices, processing engines, and/or video communication platforms. In some embodiments, one or more of the first user’s client device, additional users’ client devices, processing engine, and/or video communication platform may be part of the same computer or device.

In an embodiment, processing engine 102 may perform the methods 300, 400 or other methods herein and, as a result, provide for avatar generation in a video communications platform. In some embodiments, this may be accomplished via communication with the first user’s client device 150, additional users’ client device(s) 151, processing engine 102, video communication platform 140, and/or other device(s) over a network between the device(s) and an application server or some other network server. In some embodiments, the processing engine 102 is an application, browser extension, or other piece of software hosted on a computer or similar device or is itself a computer or similar device configured to host an application, browser extension, or other piece of software to perform some of the methods and embodiments herein.

In some embodiments, the first user’s client device 150 and additional users’ client devices 151 may perform the methods 300, 400 or other methods herein and, as a result, provide for avatar generation in a video communications platform. In some embodiments, this may be accomplished via communication with the first user’s client device 150, additional users’ client device(s) 151, processing engine 102, video communication platform 140, and/or other device(s) over a network between the device(s) and an application server or some other network server.

The first user’s client device 150 and additional users’ client device(s) 151 may be devices with a display configured to present information to a user of the device. In some embodiments, the first user’s client device 150 and additional users’ client device(s) 151 present information in the form of a user interface (UI) with UI elements or components. In some embodiments, the first user’s client device 150 and additional users’ client device(s) 151 send and receive signals and/or information to the processing engine 102 and/or video communication platform 140. The first user’s client device 150 may be configured to perform functions related to presenting and playing back video, audio, documents, annotations, and other materials within a video presentation (e.g., a virtual class, lecture, video conference, webinar, or any other suitable video presentation) on a video communication platform. The additional users’ client device(s) 151 may be configured to viewing the video presentation, and in some cases, presenting material and/or video as well. In some embodiments, first user’s client device 150 and/or additional users’ client device(s) 151 include an embedded or connected camera which is capable of generating and transmitting video content in real time or substantially real time. For example, one or more of the client devices may be smartphones with built-in cameras, and the smartphone operating software or applications may provide the ability to broadcast live streams based on the video generated by the built-in cameras. In some embodiments, the first user’s client device 150 and additional users’ client device(s) 151 are computing devices capable of hosting and executing one or more applications or other programs capable of sending and/or receiving information. In some embodiments, the first user’s client device 150 and/or additional users’ client device(s) 151 may be a computer desktop or laptop, mobile phone, video phone, conferencing system, or any other suitable computing device capable of sending and receiving information. In some embodiments, the processing engine 102 and/or video communication platform 140 may be hosted in whole or in part as an application or web service executed on the first user’s client device 150 and/or additional users’ client device(s) 151. In some embodiments, one or more of the video communication platform 140, processing engine 102, and first user’s client device 150 or additional users’ client devices 151 may be the same device. In some embodiments, the first user’s client device 150 is associated with a first user account on the video communication platform, and the additional users’ client device(s) 151 are associated with additional user account(s) on the video communication platform.

In some embodiments, optional repositories can include one or more of: a user account avatar model repository 130 and avatar model customization repository 134. The avatar model repository may store and/or maintain avatar models for selection and use with the video communication platform 140. The avatar model customization repository 134 may include customizations, style, coloring, clothing, facial feature sizing and other customizations made be a user to a particular avatar.

Video communication platform 140 comprises a platform configured to facilitate video presentations and/or communication between two or more parties, such as within a video conference or virtual classroom. In some embodiments, video communication platform 140 enables video conference sessions between one or more users.

FIG. 1B is a diagram illustrating an exemplary computer system 150 with software and/or hardware modules that may execute some of the functionality described herein. Computer system 150 may comprise, for example, a server or client device or a combination of server and client devices for avatar generation in a video communications platform.

The User Interface Module 152 provides system functionality for presenting a user interface to one or more users of the video communication platform 140 and receiving and processing user input from the users. User inputs received by the user interface herein may include clicks, keyboard inputs, touch inputs, taps, swipes, gestures, voice commands, activation of interface controls, and other user inputs. In some embodiments, the User Interface Module 152 presents a visual user interface on a screen. In some embodiments, the user interface may comprise audio user interfaces such as sound-based interfaces and voice commands.

The Avatar Model Selection Module 154 provides system functionality for selection of an avatar model to be used for presenting the user in an avatar form during video communication in the video communication platform 140.

The Avatar Model Customization Module 158 provides system functionality for the customization of features and/or the presented appearance of an avatar. For example, the Avatar Model Customization Module 158 provides for the selection of attributes that may be changed by a user. For example, changes to an avatar model may include hair customization, facial hair customization, glasses customization, clothing customizations, hair, skin and eye coloring changes, facial feature sizing and other customizations made be the user to a particular avatar. The changes made to the particular avatar are stored or saved in the avatar model customization repository 134.

The Object Detection Module 160 provides system functionality for determining an object within a video stream. For example, the Object Detection Module 160 may evaluate frames of a video stream and identify the head and/or body of a user. The Object Detection Module may extract or separate pixels representing the user from surrounding pixel representing a background of the user.

The Avatar Rendering Module 162 provides system functionality for rendering a 3-dimensional avatar based on a received video stream of a user. For example, in one embodiment the Object Detection Module 160 identifies pixels representing the head and/or body of a user. These identified pixels are then processed by the Avatar Rendering Module in conjunction with a selected avatar model. The Avatar Rendering Module 162 generates a digital representation of the user in an avatar form. The Avatar Rendering Module generates a modified video stream depicting the user in an avatar form (e.g., a 3-dimensional digital representation based on a selected avatar model). Where a virtual background has been selected, the modified video stream includes a rendered avatar overlayed on the selected virtual background.

The Avatar Model Synchronization Module 164 provides system functionality for synchronizing or transmitting avatar models from an Avatar Modeling Service. The Avatar Modeling Service may generate or store electronic packages of avatar models for distribution to various client devices. For example, a particular avatar model may be updated with a new version of the model. The Avatar Model Synchronization Module handles the receipt and storage of the electronic packages on the client device of the distributed avatar models from the Avatar Modeling Service.

The Machine Learning Network Module 166 provides system functionality for use of a trained machine learning network to evaluate image data and determine facial expression parameters for facial expressions of a person found in the image data. Additionally, the trained machine learning network may determine pose values of the head and/or body of the person. The determined facial expression parameters are used to select blendshapes to morph or adjust a 3D mesh-based model. The determined pose values of the head or body of the person are used by the system 100 to rotate and/or translate (i.e., orient on an 3D x, y, z axis) and scale the avatar (i.e., increase or decrease the size of the rendered avatar displayed in a user interface).

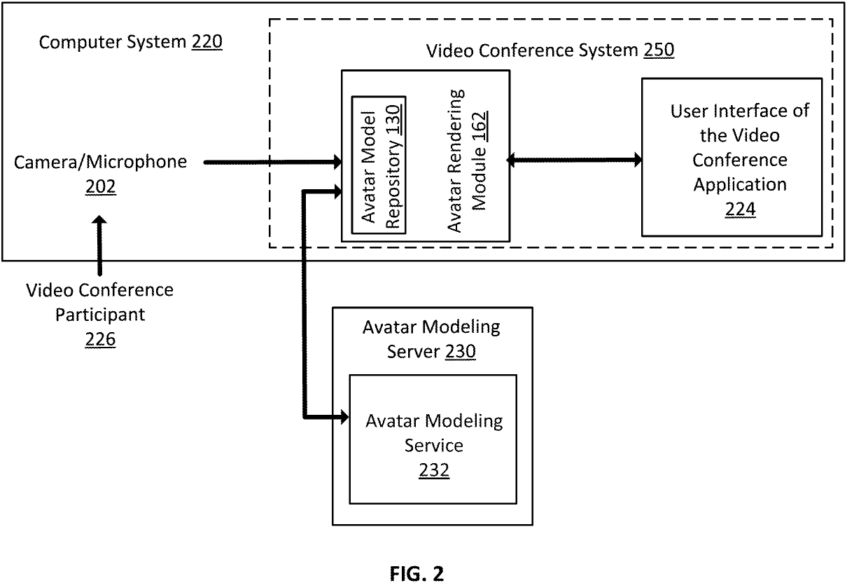

FIG. 2 illustrates one or more client devices that may be used to participate in a video conference and/or virtual environment. In one embodiment, during a video conference, a computer system 220 (such as a desktop computer or a mobile phone) is used by a Video Conference Participant 226 (e.g., a user) to communicate with other video conference participants. A camera and microphone 202 of the computer system 202 captures video and audio of the video conference participant 226. The Video Conference System 250 receives a video stream of the captured video and audio and is processed by the Video Conference System 250. Based on the received video stream, for a selected avatar model from the Avatar Model Repository 130, the Avatar Rendering Module 160 renders or generates a modified video stream depicting a digital representation of the Video Conference Participant 226 in an avatar form. The modified video stream may be presented via a User Interface of the Video Conference Application 224.

In some embodiments, the Video Conference System 250 may receive electronic packages of updated 3D avatar models which are then stored in the Avatar Model Repository 130. An Avatar Modeling Server 230 may be in electronic communication with the Computer System 220. An Avatar Modeling Service 232 may generate new or revised three-dimensional (3D) avatar models. The Computer System 220 communicates with the Avatar Modeling Service to determine whether any new or revised avatar models are available. Where a new or revised avatar model is available, the Avatar Modeling Services 232 transmits an electronic packaging containing the new or revised avatar model to the Computer System 220.

In some embodiments, the Avatar Modeling Service 232 transmits an electronic package to the Computer System 220. The electronic package may include a head mesh of a 3D avatar model, a body mesh of the 3D avatar model and a body skeleton having vector or other geometry information for use in moving the body of the 3D avatar model, model texture files, multiple blendshapes, and other data. In some embodiments, the electronic package includes a blendshape for each of the different or unique facial expression that may be identified by the machine learning network as described below. In one embodiment, the package may be transmitted as a glTF file format.

In some embodiments, the system may determine multiple different facial expressions or actions values for an evaluated image. The system 100 may include in the package, a corresponding blendshape for each of the multiple different facial expressions that may be identified by the system. The system may use the different blendshapes to adjust or deform the 3D mesh-based model (e.g,, the head mesh model) when rendering a digital representation of a Video Conference Participant 226 in avatar form.

In some embodiments, the system 100 may determine multiple different facial expressions or actions values for an evaluated image. The system 100 may include in the package, a corresponding blendshape for each of the multiple different facial expressions that may be identified by the system. The system 100 may use the different blendshapes to adjust or deform the 3D mesh-based model (e.g., the head mesh model) when rendering a digital representation of a Video Conference Participant 226 in avatar form.

The system 100 generates from a 3D mesh-based model, a digital representation of a video conference participant in an avatar form. The avatar model may be a mesh-based 3D model. In some embodiments, a separate avatar head mesh model and a separate body mesh model may be used. The 3D head mesh model may be rigged to use different blendshapes for natural expressions. In one embodiment, the 3D head mesh model may be rigged to use at least 51 different blendshapes. Also, the 3D head mesh model may have an associated tongue model. The system 100 may detect tongue out positions in an image and render the avatar model depicting a tongue out animation.

Different types of 3D mesh-based models may be used with the system 100. In some embodiments, a 3D mesh-based model may be based on three-dimensional facial expression (3DFE) models (such as Binghamton University (BU)-3DFE (2006), BU-4DFE (2008), BP4D-Spontaneous (2014), BP4D+ (2016), EB+ (2019), BU-EEG (2020) 3DFE, ICT-FaceKit, and/or a combination thereof). The foregoing list of 3D mesh-based models is meant to be illustrative and not limiting. One skilled in the art would appreciate that other 3D mesh-based model types may be used with the system 100.

In some embodiments, the system 100 may use Facial Action Coding System (FACS) coded blendshapes for facial expression and optionally other blendshapes for tongue out expressions. FACS is a generally known numeric system to taxonomize human facial movements by the appearance of the face. In one embodiment, the system 100 uses 3D mesh-based avatar models rigged with at least multiple FACS coded blendshapes. The system 100 may use FACS coded blendshapes to deform the geometry of the 3D mesh-based model (such as a 3D head mesh) to generate various facial expressions.

In some embodiments, the system 100 uses a 3D morphable model (3DMM) to generate rigged avatar models. For example, the following 3DMM may be used to represent a user’s face with expressions: v=m+Pα+Bw, where m is the neutral face, P is the face shape basis and B is the blendshape basis. The neutral face and face shape basis are created from 3D scan data (3DFE/4DFE) using non-rigid registration techniques.

The face shape basis P may be computed using principal component analysis (PCA) on the face meshes. PCA will result in principal component vectors which correspond to the features of the image data set. The blendshape basis B may be derived from the open-source project ICT-FaceKit. The ICT-FaceKit provides a base topology with definitions of facial landmarks, rigid and morphable vertices. The ICT-FaceKit provides a set of linear shape vectors in the form of principal components of light stage scan data registered to a common topology.

Instead of a deformation transfer algorithm, which gives unreliable results if the topologies of source and target meshes are distinct, in some embodiments the system 100 may use non-rigid registration to map the template face mesh to an ICT-FaceKit template. The system 100 may then rebuild blendshapes simply using barycentric coordinates. In some embodiments, to animate the 3D avatar, only expression blendshape weights w would be required (i.e., detected facial expressions).

In some embodiments, the 3D mesh-based models (e.g., in the format of FBX, OBJ, 3ds Max 2012 or Render Vray 2.3 with a textures format of PNG diffuse) may be used as the static avatars rigged using linear blend skinning with joints and bones.

The blendshapes may be used to deform facial expressions. Blendshape deformers may be used in the generation of the digital representation. For example, blendshapes may be used to interpolate between two shapes made from the same numerical vertex order. This allows a mesh to be deformed and stored in a number of different positions at once.

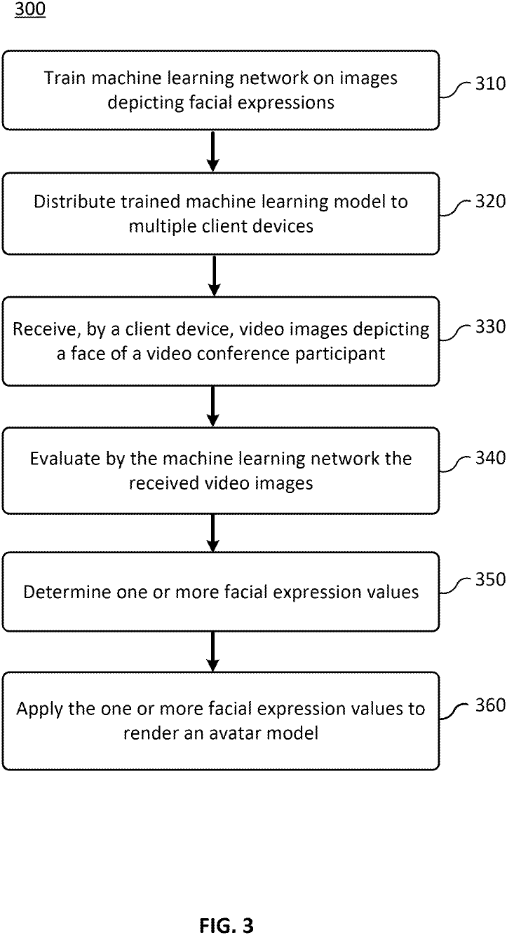

FIG. 3 is a flow chart illustrating an exemplary method 300 that may be performed in some embodiments. A machine learning network may be trained to evaluate video images and determine pose values of a person’s head and/or upper body and determine facial expression parameter values of a person’s face as depicted in an input image. In some embodiments, the system 100 may use machine learning techniques such as deep machine learning, learning-capable algorithms, artificial neural networks, hierarchical models and other artificial intelligence processes or algorithms that have been trained to perform image recognition tasks, such as performing machine recognition of specific facial features in imaging data of a person. Based on the characteristics or features recognized by the machine learning network on the image data, the system 100 may generate parameters for application to the 3D mesh-based models.

In step 310, a machine learning network may be trained on sets of images to determine pose values and/or facial expression parameter values. The training sets of images depict various poses of a person’s head and/or upper body, and depict various facial expressions. The various facial expressions in the images are labeled with a corresponding action number and an intensity value. For example, the machine learning network may be trained using multiple images of actions depicting a particular actions unit value and optionally an intensity value for the associated action. In some embodiments, the system 100 may train the machine learning network by supervised learning which involves sequentially generating outcome data from a known set of image input data depicting a facial expression and the associated action unit number and an intensity value.

Table 1 below illustrates some examples of action unit (AU) number and the associated facial expression name:

TABLE 1

| AU Number | FACS Name |
|---|---|
| 0 | Neutral face |
| 1 | Inner brow raiser |
| 3 | Outer brow raiser |
| 4 | Brow lowerer |
| 43 | Eyes Closed |
| 61 | Eyes turn left |
| 62 | Eyes turn right |
| 66 | Cross-eye |

In some embodiments, the machine learning network may be trained to evaluate an image to identify one or more FACS action unit values. The machine learning network may identify and output a particular AU number for a facial expression found in the image. In one embodiment, the machine learning network may identify at least 51 different action unit values of an image evaluated by the machine learning network.

In some embodiments, the machine learning network may be trained to evaluate an image to identify a pose of the head and/or upper body. For example, the machine learning network may be trained to determine a head pose of head right turn, head left turn, head up position, head down position, and/or an angle or titling of the head or upper body. The machine learning network may generate one or more pose values that describe the pose of the head and/or upper body.

In some embodiments, the machine learning network may be trained to evaluate an image to determine a scale or size value of the head or upper body in an image. The scale or size value may be used by the system 100 to adjust the size of the rendered avatar. For example, as a user moves closer to or farther away from a video camera, the size of the user’s head in an image changes in size. The machine learning network may determine a scale or size value to represent the overall size of the rendered avatar. Where the video conference participant is closer to the video camera, the avatar would be depicted in a larger form in a user interface. Where the video conference participant moves father away from the video camera, the avatar would be depicted in a small form in the user interface.

In some embodiments, the machine learning network may also be trained to provide an intensity score of a particular action unit. For example, the machine learning network may be trained to provide an associated intensity score of A-E, where A is the lowest intensity and E is the highest intensity of the facial action (e.g., A is trace action, B is a slight action, C is a marked or pronounced action D is a severe or extreme action, and E is a maximum action). In another example, the machine learning network may be trained to output a numeric value ranging from zero to one. The number zero indicates a neutral intensity, or that the action value for a particular facial feature is not found in the image. The number one indicates a maximum action of the facial feature. The number 0.5 may indicate a marked or pronounced action.

In step 320, an electronic version or copy the trained machine learning network may be distributed to multiple client devices. For example, the trained machine learning network may be transmitted to and locally stored on client devices. The machine learning network may be updated and further trained from time to time and the machine learning network may be distributed to a client device 150, 151, and stored locally.

In step 330, a client device 150, 151 may receive video images of a video conference participant. Optionally, the video images may be pre-processed to identify a group of pixels depicting the head and optionally the body of the video conference participant.

In step 340, each frame from the video (or the identified group of pixels) is input into the local version of the machine learning network stored on the client device. The local machine learning network evaluates the image frames (or the identified group of pixels). The system 100 evaluates the image pixels through an inference process using a machine learning network that has been trained to classify one or more facial expressions and the expression intensity in the digital images. For example, the machine learning network may receive and process images depicting a video conference participant.

At step 350, the machine learning network determines one or more pose values and/or facial expression values (such as one or more action unit values with an associated action intensity value and/or 3DMM parameter values). In some embodiments, only an action unit value is determined. For example, an image of a user may depict that the user’s eyes are closed, and the user’s head is slightly turned to the left. The trained machine learning network may output a facial expression value indicating the eyelids as the particular facial expression, and an intensity value indicating the degree or extent to which the eyelids are closed or open. Additionally, the trained machine learning network may output a pose value indicating the user’s head as being turned to the left and a value indicating the degree or extent to which the user’s head is turned.

At step 360, the system 100 applies the determined one or more pose values and/or facial expression values to render an avatar model. The system 100 may apply the action unit value and corresponding intensity value pairs and/or the 3DMM parameters to render an avatar model. The system 100 may select blendshapes of the avatar model based on the determined action unit values and/or the 3DMM parameters. A 3D animation of the avatar model is then rendered using the selected blendshapes. The selected blend shapes morph or adjust the mesh geometry of the avatar model.

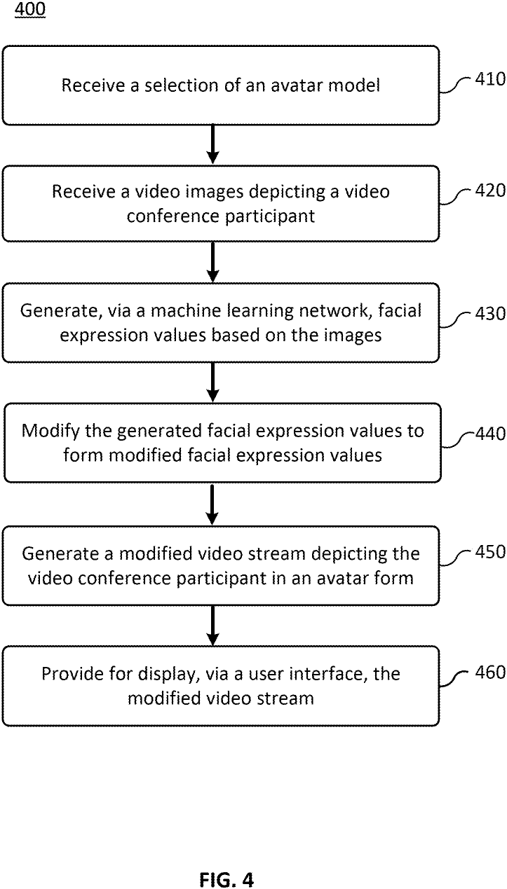

FIG. 4 is a flow chart illustrating an exemplary method 400 that may be performed in some embodiments. In some embodiments, the system 100 provides for processing and translating a received video stream of a video conference participant into a modified video stream of the video conference participant in an avatar form.

At step 410, the system 100 receives the selection of an avatar model. In one embodiment, once selected, the system 100 may be configured to use the same avatar model each time the video conference participant participates in additional video conferences.

At step 420, the system 100 receives a video stream depicting imagery of a first video conference participant, the video stream includes multiple video frames and audio data. In some embodiments, the video stream is captured by a video camera attached or connected to the first video conference participant’s client device. The video stream may be received at the client device, the video communication platform 140, and/or processing engine 102. The video stream includes images depicting the video conference participant.

In some embodiments, the system 100 provides for determining a pixel boundary between a video conference participant in a video and the background of the participant. The system 100 retains the portion of the video depicting the participant and removes the portion of the video depicting the background. In one mode of operation, when generating the avatar, the system 100 may replace the background of the participant with the selected virtual background. In another mode of operation, when generating the avatar, the system 100 may use the background of the participant, with the avatar overlaying the background of the participant.

At step 430, the system 100 generates pose values and/or facial expression values (such as FACS values and/or 3DMM parameters) for each image or frame of the video stream. In some embodiments, the system 100 determines facial expression values based on an evaluation of image frames depicting the video conference participant. The system 100 extracts pixel groupings from the image frames and processes the pixel groupings via a trained machine learning network. The trained machine learning network generates facial expression values based on actual expressions of the face of the video conference participant as depicted in the images. The trained machine learning network generates pose values based on the actual orientation/position of the head of the video conference participant as depicted in the images.

At step 440, the system 100 modifies or adjusts the generated facial expression values to form modified facial expression values. In some embodiments, the system 100 may adjust the generated facial expression values for mouth open and close expressions, and for eye open and close expressions.

At step 450, the system 100 generates or renders a modified video stream depicting a digital representation of the video conference participant in an animated avatar form based at least in part on the pose values and the modified facial expression values. The system 100 may use the modified facial expression values to select one or more blendshape and then apply the one or more blendshape at an associated intensity level to morph the 3D-mesh model. The pose values and the modified facial expression values are applied to the 3D mesh-based avatar model to generate a digital representation of the video conference participant in an avatar form. As a result, the head pose and facial expressions of the animated avatar then closely mirror the real-world physical head pose and facial expressions expressed by the video conference participant.

At step 460, the system 100 provides for display, via a user interface, the modified video stream. The modified video stream depicting the video conference participant in an avatar form may be transmitted to other video conference participants for display on their local device.

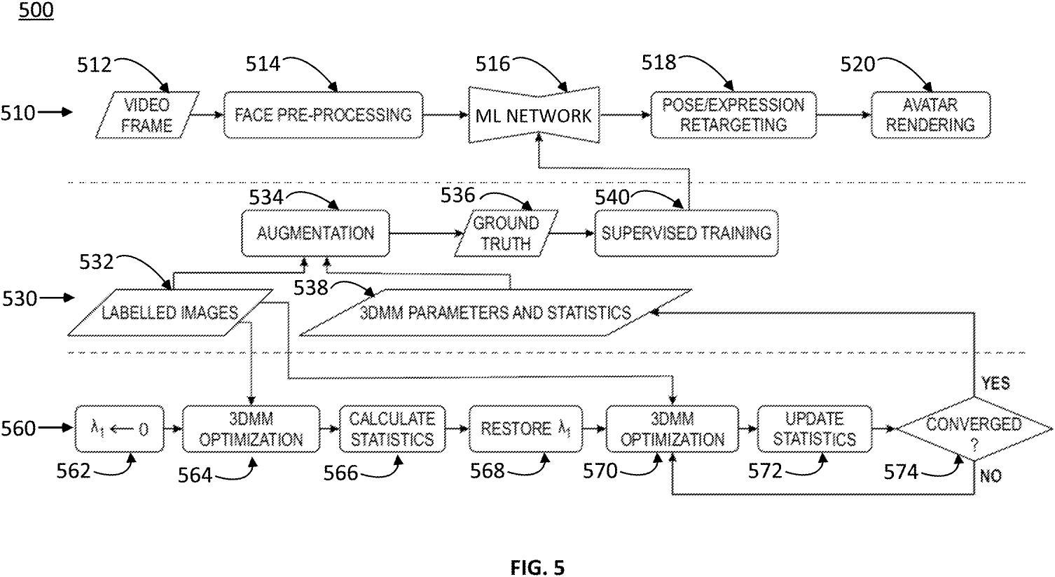

FIG. 5 is a diagram illustrating an exemplary process flow 500 that may be performed in some embodiments. The diagram illustrates training and optimization of a machine learning network (e.g., the ML Network 516) for image facial tracking and generation of facial expression and/or pose values for rendering an avatar. The system 100 may optionally perform the retargeting step 518 to retarget (i.e., change or modify) a head pose and/or facial expression of a user to a different head pose or facial expression when rendering the avatar.

Generally, the process flow 500 may be divided into three separate processes of image tracking 510, ML Network training 530, and 3DMM parameter optimization 560. In the image tracking process 510, the system 100 performs the process of obtaining images of a user and uses the ML Network to generate parameters from the images to render an animated avatar. In step 512, the system 100 obtains video frames depicting a user. For example, during a communications session, the system 100 may obtain real-time video images of a user. In step 514, the system 100 may perform video frame pre-processing, such as object detection and object extraction to extract a group of pixels from each of the video frames. In step 514, the system 100 may resize the group of pixels to a pixel array of a height h and a width w. The extracted group of pixels includes a representation of a portion of the user, such as the user’s face, head and upper body. In step 516, the system 100 then inputs the extracted group of pixels into the trained ML Network 516. The trained ML Network 516 generates a set of pose values and/or facial expression values based on the extracted group of pixels. In step 518, the system 100 may optionally adjust or modify the pose values and/or facial expression values generated by the ML Network 516. For example, the system 100 may adjust or modify the facial expression values thereby retargeting the pose values and/or facial expression values of the user. The system 100 may determine adjustments to the facial expression values, such as modifying the facial expression values for the position of the eye lids and/or the position of the lips of the mouth. In step 520, the system 100 may then render and animate, for display via a user interface, a 3D avatar’s head and upper body pose, and facial expressions based on the ML Network generated pose and facial expression values and/or modified pose and facial expression values.

In some embodiments, the system 100 may perform a training process 530 to train an ML Network 516. The training process 530 augments the image data 532 of the training data set. The system 100 may train the ML Network 516 to generate facial expression values of 3DMM parameters based on a training set of labeled image data 532. The training set of image data 532 may include images of human facial expressions having 2D facial landmarks identified in the respective images of the training set. The 3DMM parameters 538 may include 3D pose values, facial expressions values, and user identity values. In step 534, for each facial image of the training data set, together with its 3DMM parameters 538, the system 100 may augment the facial images 532 to generate ground-truth data 536. In step 540, the system 100, using supervised training, may train the ML Network 516 to determine (e.g., inference) 3DMM parameters based on the generated ground-truth data. The system 100 may distribute the trained ML Network 516 to client devices where a respective client device may use the trained ML Network 516 to inference image data to generate the pose and/or facial expression values.

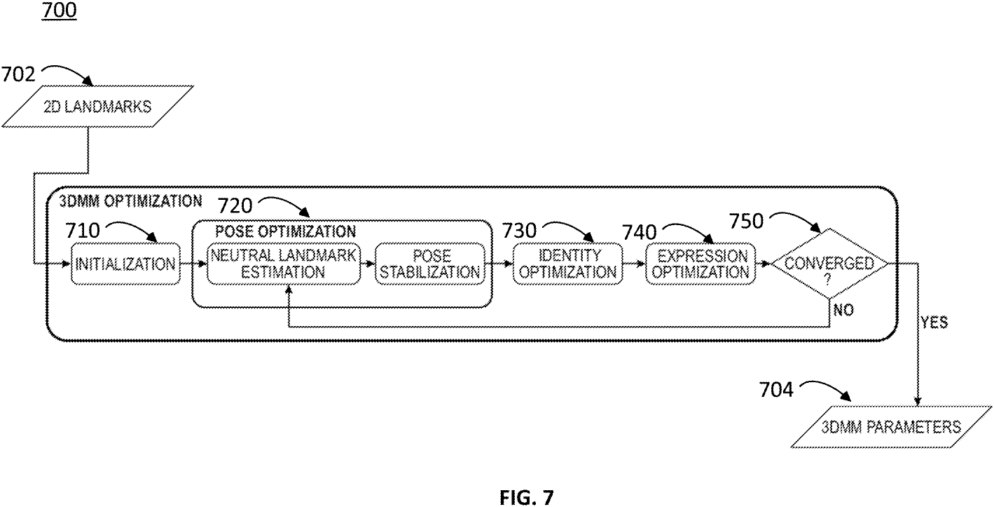

In some embodiments, the system 100 may perform an optimization process 560 to optimize the 3DMM parameters 538 that are used in the augmentation step 534. The optimization process 560 is further described with regard to 3DMM optimization set forth in reference to FIG. 7

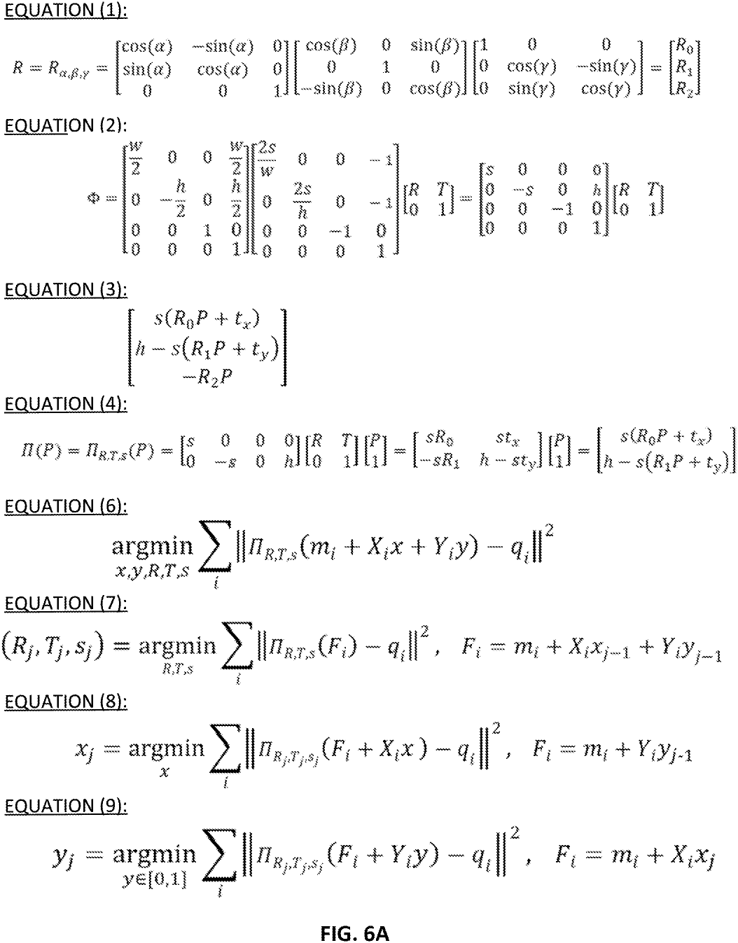

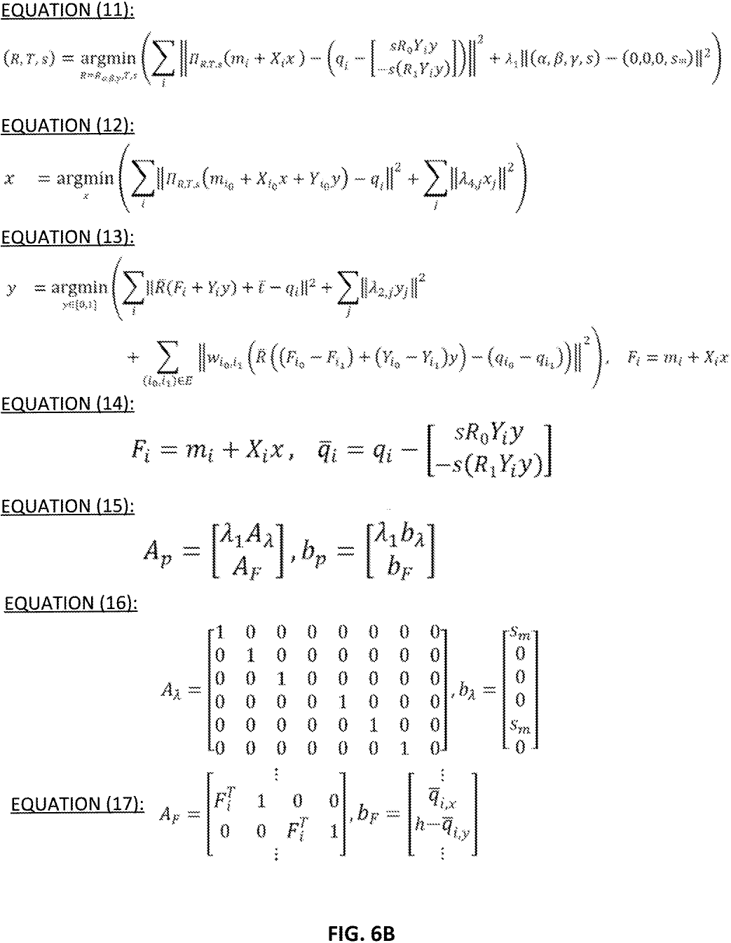

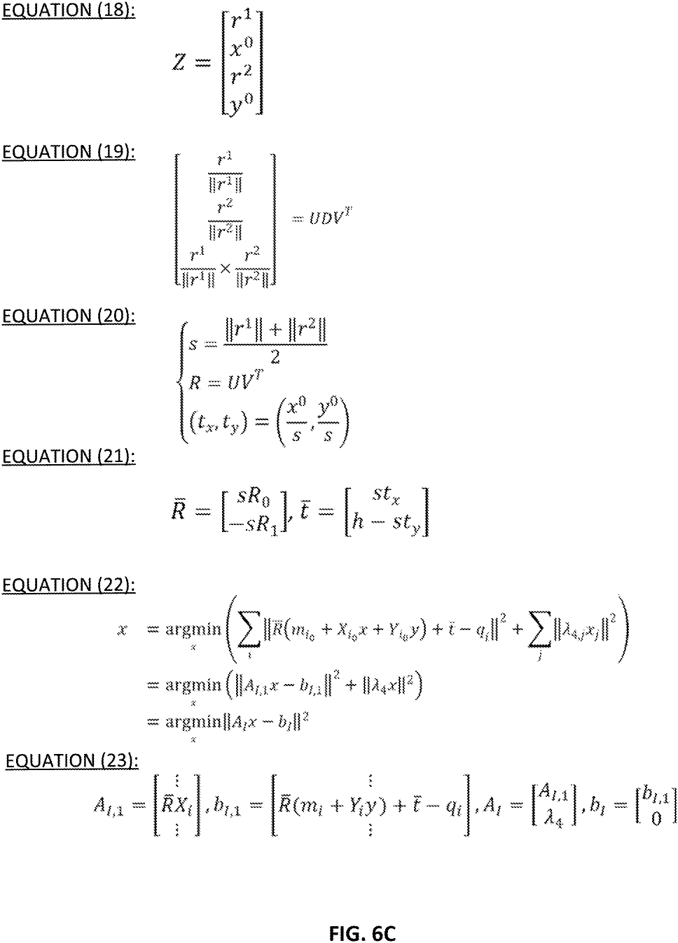

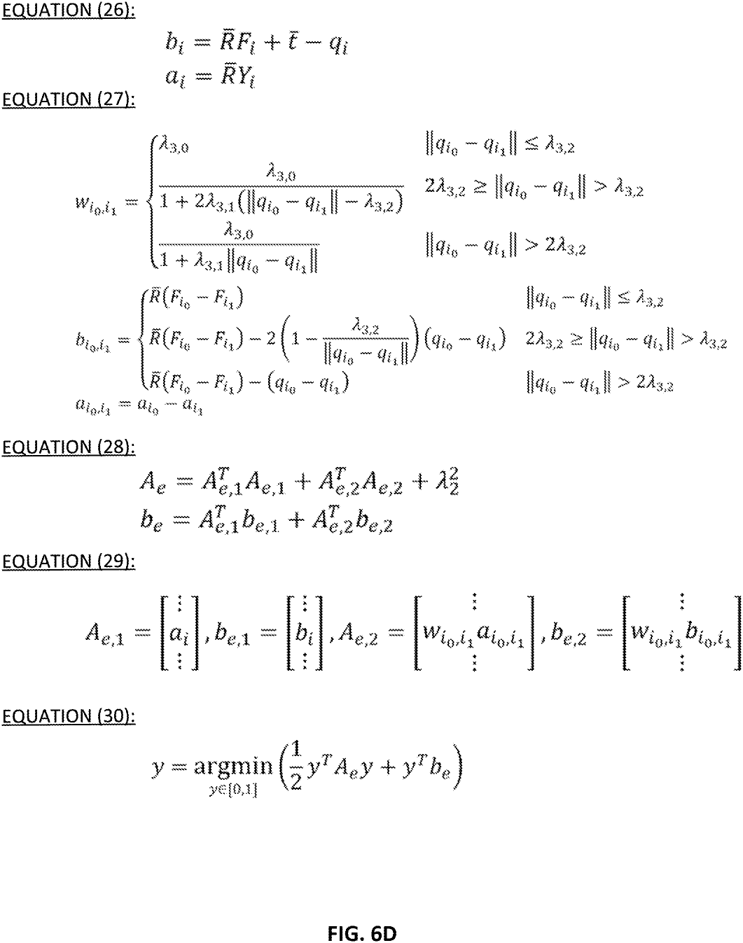

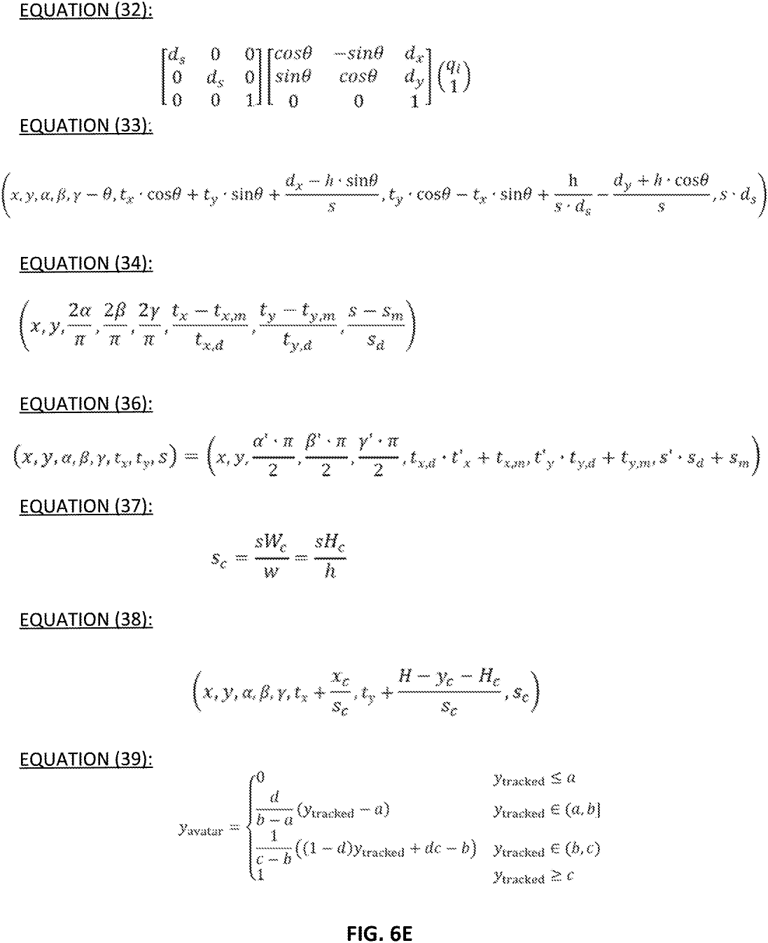

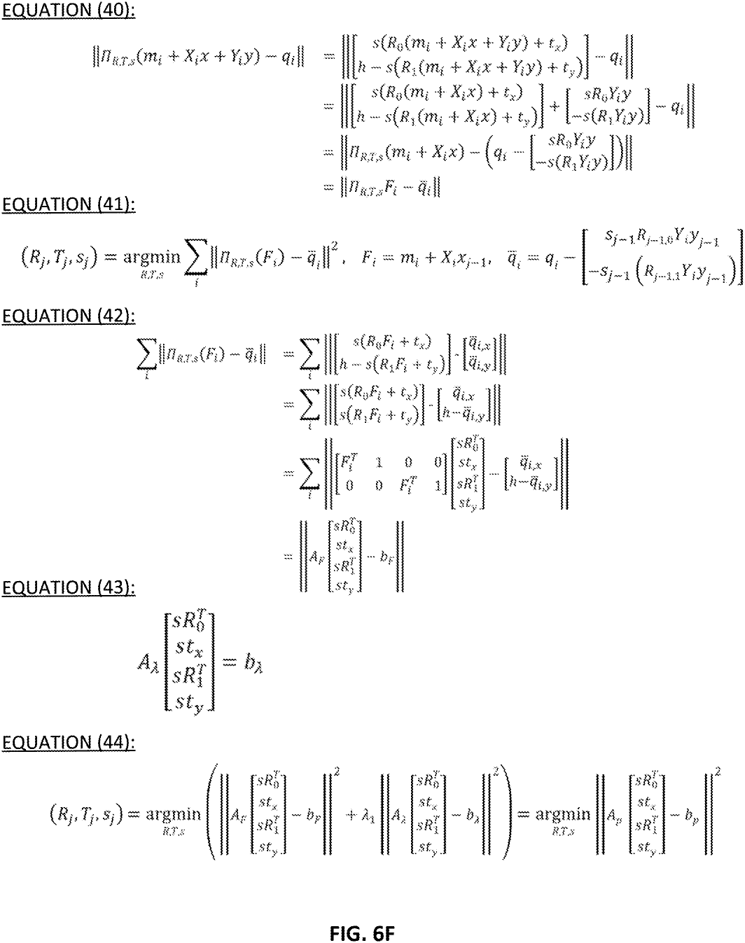

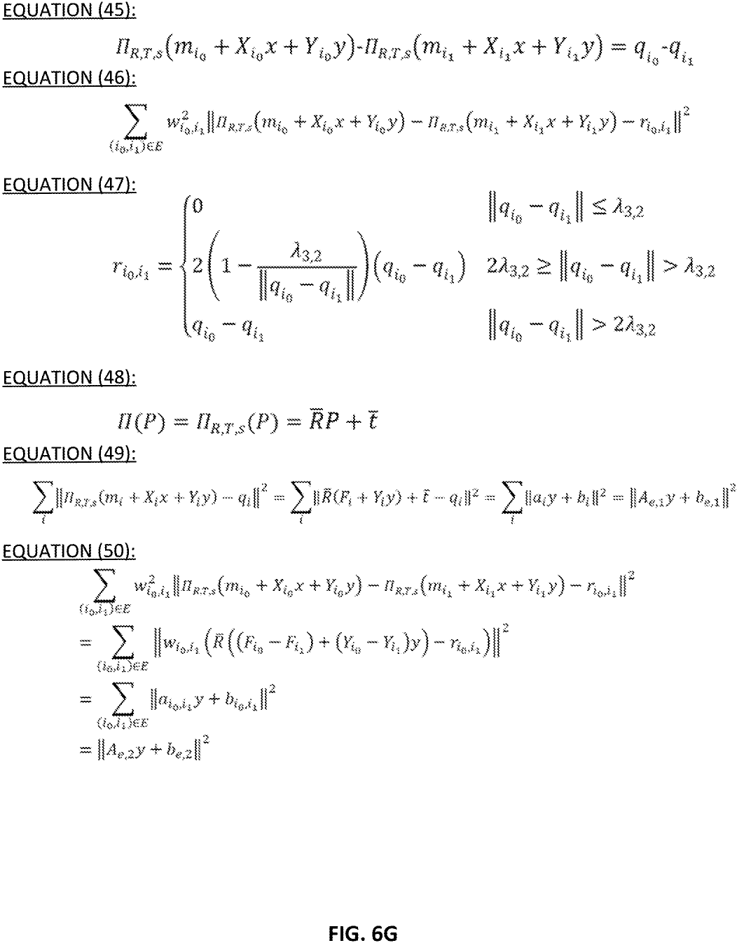

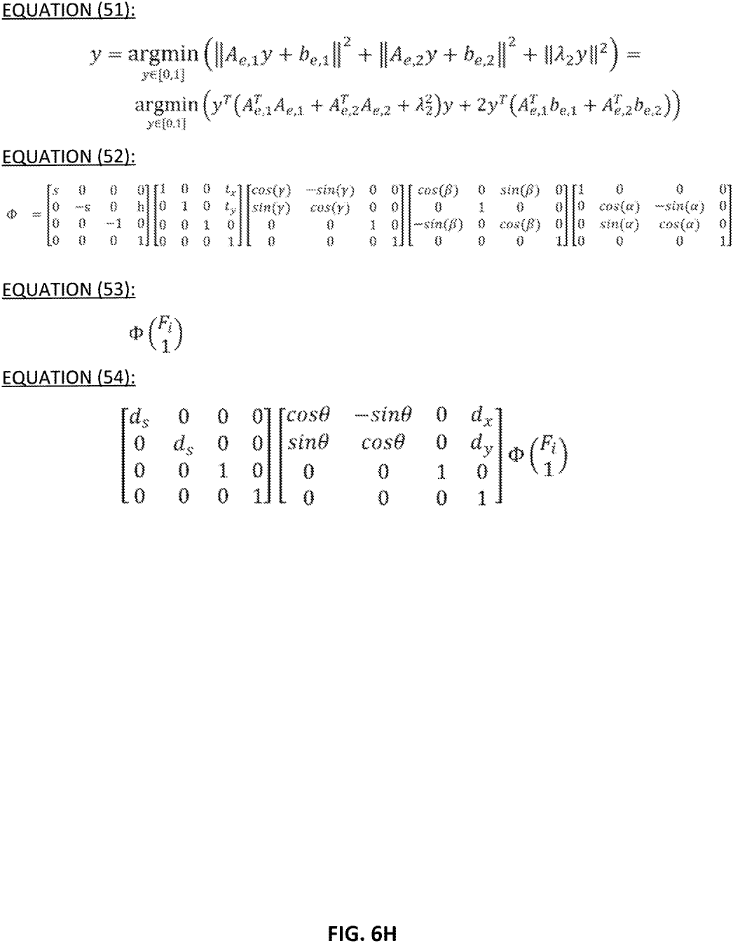

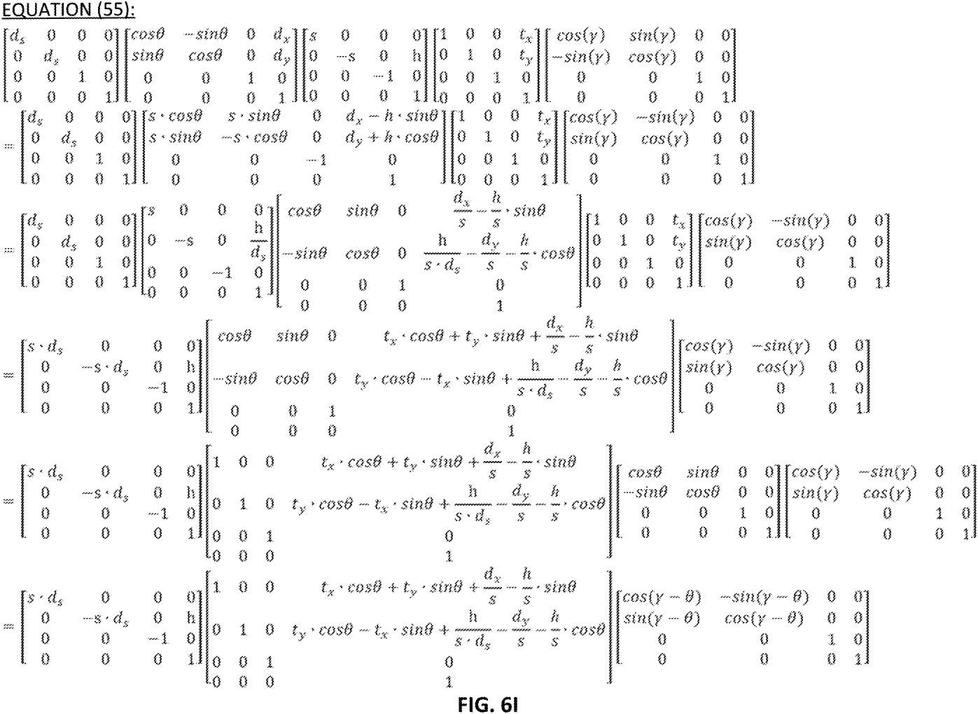

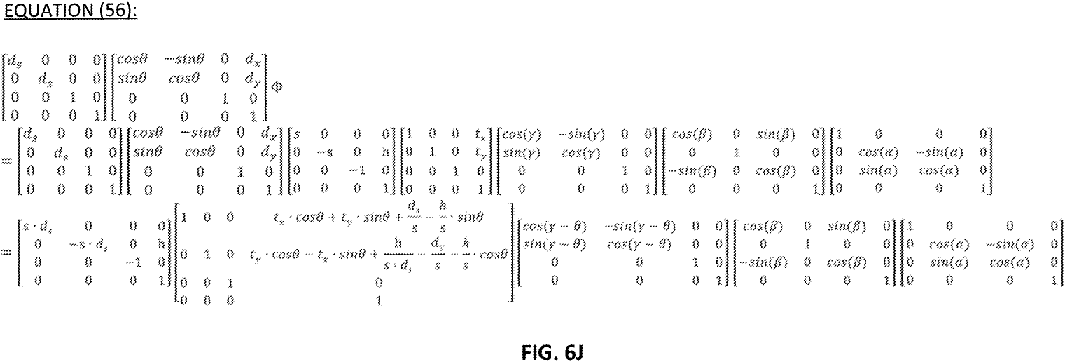

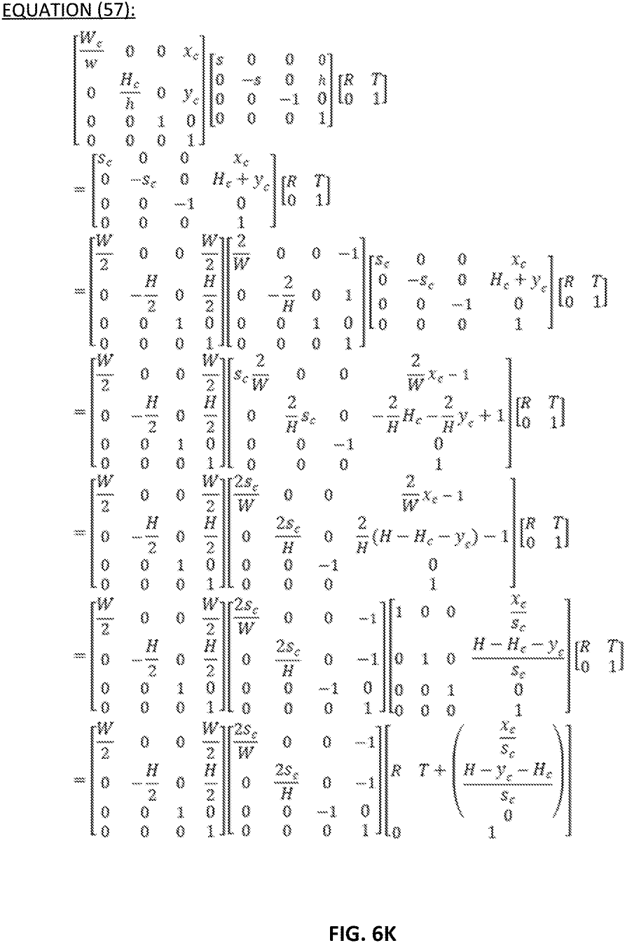

FIGS. 6A-6K are diagrams illustrating exemplary equations referenced throughout the specification. These equations are referenced by an Equation (number). In some embodiments, an image may have associated 3DMM parameters including: (1) facial expression values described by (x,y,R,T,s), (2) pose values of a pose vector described by (R,T,s)=(α,β,γ,tₓ,t_{y},s), (3) an identity vector described by x, and (4) an expression vector described by y. The pose vector may be denoted as (R,T,s)=(α,β,γ,tₓ,t_{y},s), and may be described as α, β, γ (e.g., three Euler angles for defining a 3D rotation R) according to Equation (1), where Rᵢ is the (i+1)-th row of R, where tₓ,t_{y} is the translation, where T=(tₓ,t_{y},0)^{T,}, and S is described for scaling. The system 100 uses the pose vector to provide for three-dimensional orientation and sizing of a rendered avatar.

Given a viewport of height h and width w, a projection matrix corresponding to the pose (R,T,s) may be described according to Equation (2). The projection matrix projects a 3D point, P, into the 3D viewport as illustrated by Equation (3). The scaled orthographic projection (SOP), Π, projects a 3D point, P, into a 2D point linearly as illustrated by Equation (4). A 3D human face, having an identity parameter x and an expression parameter y, which may be described as F = m + Xx + Yy (referred to herein as Equation (5)), where m is the mean face, X is the principle component analysis (PCA) basis, and Y is the expression blendshapes. The 3DMM parameters may be used for the selection and application of intensity values for particular blendshapes to the avatar 3D mesh model.

Referring back to FIG. 5, the system 100 may train the ML Network 516 to derive 3DMM parameters from a group of pixels from an input facial image. In some embodiments, the ML Network 516 may be based on MobileNetV2 as an underlying machine learning network. The MobileNetV2 machine learning network generally provides computer vision neural network functionality and may be configured for classification and detection of objects using the mage input data. MobileNetV2 has a convolutional neural network architecture. While a convolutional neural network architecture is used in some embodiments, other types of suitable machine learning networks may be used for deriving the 3DMM parameters.

In some embodiments, the MobileNetV2 neural network may be trained on a data set of ground truth image data 536 depicting various pose and facial expressions of a person. The ground truth 3DMM parameters may be generated using optimization techniques as further described herein. The data set of ground truth data 536 may include images of human faces that are labeled and identify 2-dimensional facial landmarks in an image. Each human face in an image may include labeled facial landmarks and may be described by qᵢ. For each facial landmark qᵢ, the system 100 may perform the optimization process 560 as described below to derive optimal 3DMM parameters (x,y,R,T,s). The optimization process 560 may minimize the distance between projected 3D facial landmarks and input 2D landmarks according to Equation (6), where the subscript i refers to the i-th landmark on the mean face, PCA basis and expressions. Equation (6) may be solved by coordinate descent where the system 100 iteratively performs three processes of (a) pose optimization, (b) identity optimization and (c) expression optimization until converges occurs.

The system 100 may begin the optimization process 560 with an initialization step. The system may initialize (x₀,y₀,R₀,T₀,s₀) = 0. The system 100 may perform j iterations of processes, where the j-th iteration derives the 3DMM parameters (xⱼ,yⱼ,Rⱼ,Tⱼ,sⱼ). The system 100 may perform the pose optimization process to optimize the pose based on identity xⱼ₋₁ and expression yⱼ₋₁ from previous iteration according to Equation (7) or the improved version Equation (11). The system 100 may perform an identity optimization process to optimize the identity based on pose (Rⱼ,Tⱼ,sⱼ) and expressions yⱼ₋₁ according to Equation (8) or the improved version Equation (12). The system 100 may perform the expression optimization process on the pose (Rⱼ,Tⱼ,sⱼ) and the identity xⱼ according to Equation (9) or the improved version Equation (13).

The system 100 may perform an avatar retargeting process 520 to modify or adjust an expression of a user. In some embodiments, the system 100 may use an avatar model with expression parameter yₐ as described in the equation Fₐ = mₐ + Yₐ yₐ (referred herein as Equation (10)), where mₐ is the avatar without expressions, and Yₐ is the expression blendshapes. The avatar retargeting process may generate two data outputs, which include the avatar’s expression yₐ mapped from tracked human expression y, and the avatar pose converted from the tracked human pose (R, T,s)=(a, β, γ, tₓ, t_{y},s). The system 100 may use these two data outputs to construct Equation (2) for rendering of the avatar via a user interface.

The system 100 does not need to perform the optimization process 560 on the augmented images. Rather, the system 100 may derive the 3DMM parameters directly during the augmentation process 534. Augmented 3DMM parameters may be normalized according to the statistical mean (tₓ,ₘ,t_{y},ₘ,Sₘ) and deviation (t_{x,d}, t_{y,d}, S_{d}).

The optimization process 560 outputs 3DMM parameters for all the labeled images 532 of the training data set. The system 100 may perform the optimization process 560 multiple times. Each performance of the optimization process 560 is based on an evaluation of each of the images in the training data set 532. In step 562, in a first run of the 3DMM optimization process 564, a system parameter λ₁ is replaced with zero. As such, pose optimization in Equation (11) does rely on sₘ. In step 566, statistical mean (t_{x,m},t_{y,m},sₘ) and deviation (t_{x,d}, t_{y,d},s_{d}) for the translation and scaling are collected after each run of the 3DMM optimization process. In the subsequent runs of the optimization process 560, λ₁ is restored (step 568), and pose optimization in Equation (11) relies on sₘ. The system 100 repeats the 3DMM optimization process 570 until sₘ is converged (decision 574).

The system 100 may perform the optimization process using the following parameters. λ₁ is a parameter for pose stabilization as used in the pose optimization Equation (11). λ_{2,j} is a regularization parameter for the j-th expression, to be used in the expression optimization Equation (13). λ₂ is a parameter for a square diagonal matrix with λ_{2,j} on the main diagonal, to be used in expression optimization. (λ_{3,0},λ_{3,1},λ_{3,2}) are parameters for distance constraints to be used in expression optimization. Different parameters may be used for the two eye regions (j=0) and the mouth region (j=1) with (λ_{3,0},λ_{3,1},λ_{3,2})=(λ^{j}_{3,0},λ^{j}_{3,1},λ^{j}_{3,2}), where λ^{j}_{3,0} is a parameter for the maximum weight, λ^{j}_{3,1} is a parameter for the decay parameter, λ^{j}_{3,0}, and the distance threshold. The parameter λ_{4,j} is a regularization parameter for the j-th face PCA, to be used in the identity optimization Equation (12). The λ₄ parameter may be used for a square diagonal matrix with λ_{4,j} on the main diagonal, to be used in identity optimization.

The system 100 may use the following inputs and constraints. The variable qᵢ may be used for describing the i-th 2D landmark of an image. The variables mᵢ, Xᵢ, Yᵢ may be used for describing the i-th 3D landmark on the mean face, PCA basis and expressions. The variable n₁ may be used to identify the number of landmarks. The variables (t_{x,m}, t_{y,m},sₘ), (t_{x,d},t_{y,d},s_{d}) may be used for the statistical mean and deviation of the parameters (t_{x,}t_{y},s) on all of the images 532. With λ₁=0, the system 100 may perform the 3DMM optimization process (564, 570) to derive pose (α,β,y,tₓ,t_{y},S) for each image, and calculate the mean for the translation and scaling. The 3DMM optimization process (570) requires sₘ only when λ₁>0. The variable (i₀, i₁)∈E may be used for describing a pair of landmarks for formulating a distance constraint. The variable n₂=|E| may be used for describing the number of pairs for distance constraints. The variable n₃ may be used for describing the number of expressions. The variable n₄ may be used for describing the number of facial PCA basis. The variable h may be used for describing the height of the viewport (i.e., the height of the facial image). The facial images may be scaled to a size of 112 pixels × 112 pixels, thus h = 112.

FIG. 7 is a diagram illustrating an exemplary process flow 700 that may be performed in some embodiments. The flow chart illustrates a process 700 for 3DMM parameter optimization (i.e., step 564 and/or step 570 of the optimization process 560). According to FIG. 7, 3DMM optimization takes 2D landmarks 702 of a facial image as input, and outputs 3DMM parameters 704. The system 100 may perform an initialization step 710 to initialize the 3DMM parameters as (x,y,R,T,s)=(0,y₀,R₀,T₀,s₀). The pose optimization step 720 updates the pose as according to Equation (11). The identity optimization step 730 updates the identity as illustrated by Equation (12). The expression optimization step 740 updates the expression as illustrated by Equation (13). The system 100 may initialize (x,y,R,T,s) = 0. In pose optimization step 720, the system 100 may update the pose (R,T,s). In expression optimization step 740, the system 100 may update expression y.

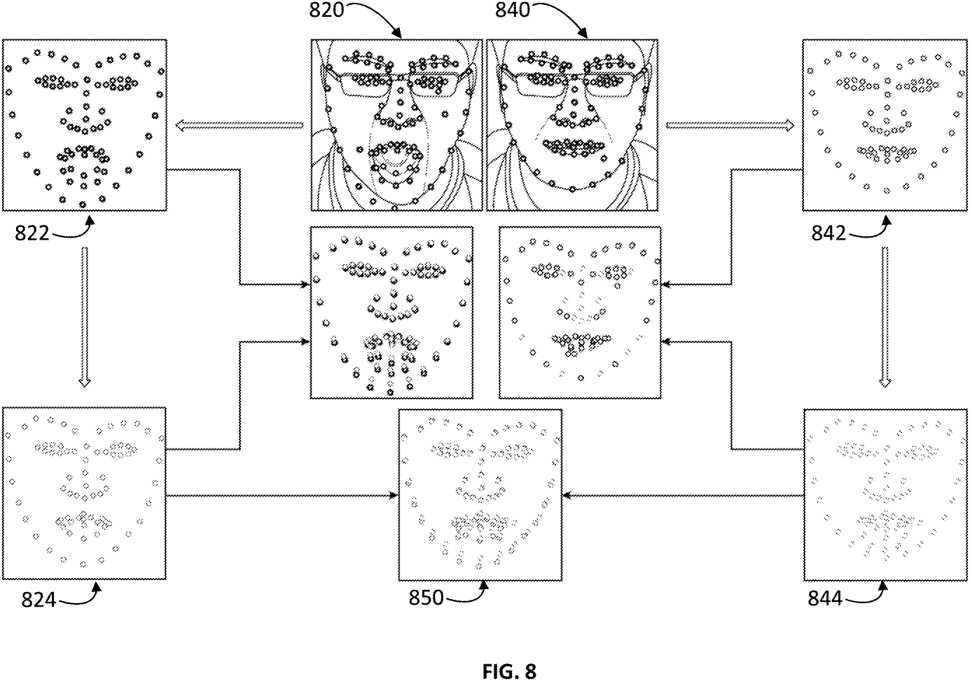

In the pose optimization step 720, the system 100 may estimate neutral landmarks of an image based on the pose, the identity, and the expressions from the previous iteration as illustrated by Equation (14). The estimation and use of neutral landmarks is further described below in reference to FIG. 8. The system 100 may construct a (2n₁+6)×8 matrix Aₚ, and a (2n₁+6)×1 matrix bₚ as illustrated by Equation (15), where 6×8 matrix A_{λ}, 6×1 matrix b_{λ}, 2n₁×8 matrix A_{F}, and 2n₁×1 matrix b_{F} are defined according to Equation (16) and Equation (17). The system 100 may solve linear equations AₚZ=bₚ to determine Equation (18). The system 100 may construct a 3×3 matrix, and apply singular value decomposition (SVD) onto the constructed matrix to obtain matrix U, V according to Equation (19). The system 100 may derive the optimized pose according to Equation (20), with the simplified pose being illustrated by Equation (21). The simplified pose is to be used in Equations (23, 26 and 27).

In the identity optimization step 730, given the expression and the pose, identity optimization of Equation (12) which may be formulated as Equation (22), where 2n₁×n₄ matrix A_{I,1}, 2n₁×1 matrix b_{I,1}, (2n₁+n₄)×n₄ matrix A_{I}, and (2n₁+n₄)×1 matrix b_{I} are defined according to Equation (23). As such, the system 100 may obtain the optimized identity by solving A_{I}x = b_{I} (referred herein as Equation (24)).

In the expression optimization step 740, given the identity and the pose, constant values may be denoted according to Fᵢ = mᵢ ₊Xᵢ x (referred to herein as Equation (25)). Each landmark of an image may be defined as illustrated by Equation (26). For each distance constraint (i₀, i₁)∈E with parameters (λ_{3,0},λ_{3,1},λ_{3,2}), may be define as illustrated by Equation (27). Variables in Equation (26) and Equation (27) may be used to form n₃×n₃ matrix Aₑ, and n₃×1 matrix bₑ according to Equation (28), where 2n₁×n₃ matrix A_{e,1}, 2n₁×1 matrix b_{e,1}, 2n₂×n₃ matrix A_{e,2}, and 2n₂×1 matrix b_{e,2} are defined according to Equation (29). The system 100 may determine the expressions from this quadratic programming problem according to Equation (30).

Referring to the ML Network training 530 of FIG. 5, the augmentation step 534 is further described. For each training image with 2D landmarks qᵢ, the optimization process 560 derives the 3DMM parameters as (x,y, α, β, γ, tₓ, t_{y},s) (referred to herein as Equation (31)). Geometric augmentations on each image includes scaling dₛ, rotation of angle θ, and 2D translation (dₓ,d_{y}). The 2D landmarks for the augmented image may be determined according to Equation (32). The system 100 may derive the 3DMM parameters for the augmented image without performing optimization process 560 according to Equation (33). Given statistical mean (t_{x,m}, t_{y,m},sₘ) and deviation (t_{x,d},t_{y,d},s_{d}), the 3DMM parameters (x,y,α, β,γ, tₓ,t_{y},s) for each image may be normalized as set forth in Equation (34).

Referring to the image tracking process 510 of FIG. 5, the system 100 may obtain video imagery of a user and perform pose retargeting via step 518. In step 514, a human face on a video frame may be tracked as a rectangle region as (x_{c},y_{c}, W_{c}, H_{c}) (referred herein as Equation (35)), where (x_{c},y_{c}) is the corner, W_{c} is its width, and H_{c} is its height. The system 100 may scale the facial image to h×h, and then use the scaled facial image as input to the ML Network 516. The ML Network 516 is trained based on the normalized 3DMM parameters in Equation (34). The resultant 3DMM parameters (x′,y′,α′,β′,γ′,t′ₓ,t′_{y},s′) generated by the ML Network 516 are also normalized, and thus may be reverted back to normal 3DMM parameters in Equation (36). Based on Equation (35) and Equation (36), Equation (37) may be determined by the system 100. The 3DMM parameters in Equation (36) are based on image pixel grouping of a size of h×h (i.e., h pixels x h pixels). The system 100 may convert the image pixel grouping to 3DMM parameters for the original video frame as according to Equation (38).

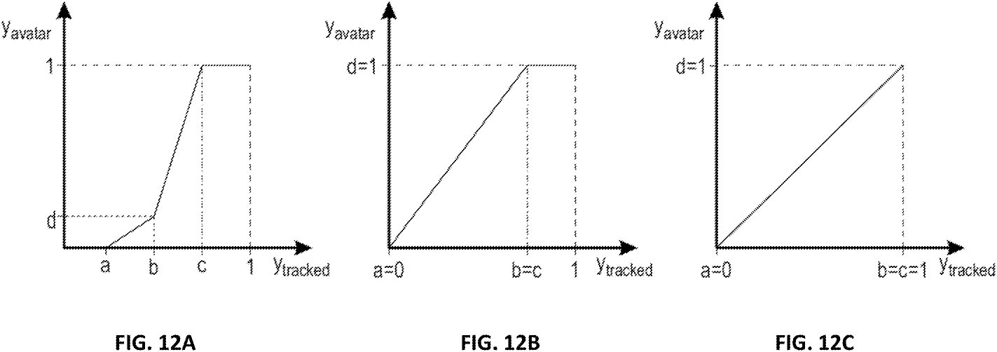

Referring to the image tracking process 518 of FIG. 5, the system 100 may retarget 3DMM parameters generated by the ML Network 516 (such as pose values and/or facial expressions values). For example, eye blink expressions of a user are normally very fast. Rendering an avatar with the generated 3DMM parameters may lead to the depiction of an avatar with an eye completely being closed. The system 100 may apply a smoothing operation on eye blink facial expressions to prevent the eye of the avatar from completely closing. The system 100 may smooth one or more of the generated facial expression parameter values to reduce a change in intensity from a first intensity level of a facial expression depicted in a first image to a second intensity level for the facial expression depicted in a subsequent image. For example, the system 100 may apply a filter (e.g., a one Euro filter) to smooth the tracked expressions except for the eye blink expressions. The system 100 may retarget the new expressions to the avatar. For each human expression y_{tracked}, the retargeted avatar expression yₐᵥₐₜₐᵣ may be described according to Equation (39), where (a,b,c,d) are customized parameters for each expression. Expression retargeting from a user image to an avatar is further described below in reference to FIGS. 12A-12C.

FIG. 8 is a diagram illustrating the use of neutral landmarks for pose optimization. The system 100 may use neutral landmarks rather than the actual landmarks of an image. FIG. 8 illustrates pose optimization based on neutral 2D landmarks 824, 844, in particular pose optimization based on neutral 2D landmarks. The figure illustrates 2D landmarks for mouth open 822, 2D landmarks for mouth close 842, estimated neutral 2D landmarks for mouth open 824, estimated neutral 2D landmarks for mouth close 844, and a comparison of two sets of neutral 2D landmarks 850. The 2D landmarks are denoted by the circular dots in the images. In a first image 820, the user makes a large open mouth expression while keeping the user’s pose in a fixed position. In a second image 840, the user makes a closed mouth expression while keeping the user’s pose in a fixed position.

During pose optimization in Equation (7), the pose in an image may be optimized to achieve the best fitting of projecting 3D landmarks Fᵢ to 2D landmarks qᵢ. As illustrated, the 2D landmarks 822 and the 2D landmarks 842 change significantly in their position for the 2D landmarks as between image 820 and image 840. In this situation, with a significant distance in the positions of the 2D landmarks from image 820 to image 840, using the optimizing Equation (7) may not provide ideal results. To address this situation, the system 100 may estimate neutral 2D landmarks for each face (such as the neutral 2D landmarks 824 for the mouth open position and with neutral 2D landmarks 844 for the closed mouth position)). This allows the system 100 to reduce the differences in the 2D landmarks (as depicted in 2D landmarks 850), and as such, the system’s optimization of the pose would be more stable. Applying Equation (4) into landmark error equation gives the Equation (40), where, according to Equation (14) Fᵢ is the i-th 3D landmark from the user’s neutral face, and q̅i̅ is the i-th neutral 2D landmark. Therefore, instead of Equation (7), the system 100 may determine the pose optimization of the j-th iteration based on neutral 2D landmarks estimated using pose and expression from the (j-1)-th iteration, which leads to the first term in Equation (11) as illustrated in Equation (41).

The system 100 may perform additional stabilization processing for pose optimization. Where ground-truth pose (α,β,γ,tₓ,t_{y},s) is optimized such that (α,β,γ,s) is close to (0,0,0,sₘ), the ML Network 516 may learn the same way when inferencing poses for two neighboring frames. As such, the system 100 may improve tracking smoothness and consistency. The system 100 may determine pose optimization by evaluating Equation (11), and noting that in the Equation (42), where A_{F} and b_{F} are defined in Equation (17). Since the constraint (α,β,γ,s)=(0,0,0,sₘ) equals to R=3×3 identity matrix and s=sₘ, the constraint may be formulated as Equation (43), where A_{λ} and b_{λ} are defined in Equation (16). Therefore, the optimization becomes the Equation (44). Hence, the solution in Equation (18) gives [sR₀, stₓ,sR₁, st_{y}]^{T}. As such, the system 100 may determine the optimized posed by evaluation Equation (20).

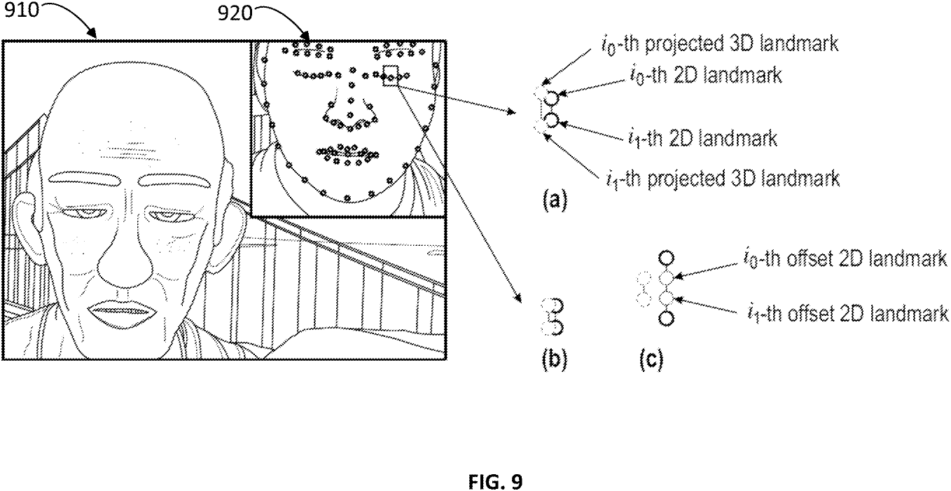

FIG. 9 is a diagram illustrating adaptive distance constraints for closed eye expressions. The system 100 may use adaptive distance constraints for expression optimization. FIG. 9 depicts different constraints for closed eye expressions. Bold circles for 2D landmarks, dashed circles depict projected 3D landmarks, and non-bolded circles depict offset for 2D landmarks.

The expression optimization in Equation (9) considers 2D landmark fitting. Equation (9) may not achieve optimal tracking results for closed eye expressions and/or closed mouth expressions. The eye regions, as depicted in FIG. 9, the user image 920, shows two 2D landmarks (e.g., i₀, i₁ 2D landmarks) of the upper eye lid and the lower eye lid that are very close to each other. The system 100 may project or determine 3D landmarks (e.g., i₀,i₁ 3D projected landmarks) corresponding to the 2D landmarks. The projected 3D landmarks may have a distance greater between i₀ and i₁, than i₀ and i₁ of the 2D landmarks. As a result, the gap between the two projected 3D landmarks (i₀, i₁) may increase, leading to an inaccurate expression. In other words, the retargeting may not depict the avatar with its eyes closed.

To improve the result of the expression retargeting for the eyes and/or mouth, the system 100 may add a distance constraint as described by Equation (45). In rendering the avatar, the tiny gap between the two 2D landmarks (i₀, i₁) may prevent the eyes from closing completely. The system 100 may use different distance constraints for eye regions and mouth regions. For eye regions, a tiny gap between 2D landmark pairs may be removed to make the eye close completely. For the mouth region, the tiny gaps between 2D landmark pairs for mouth expressions may be controlled via a predetermined graph or scale.

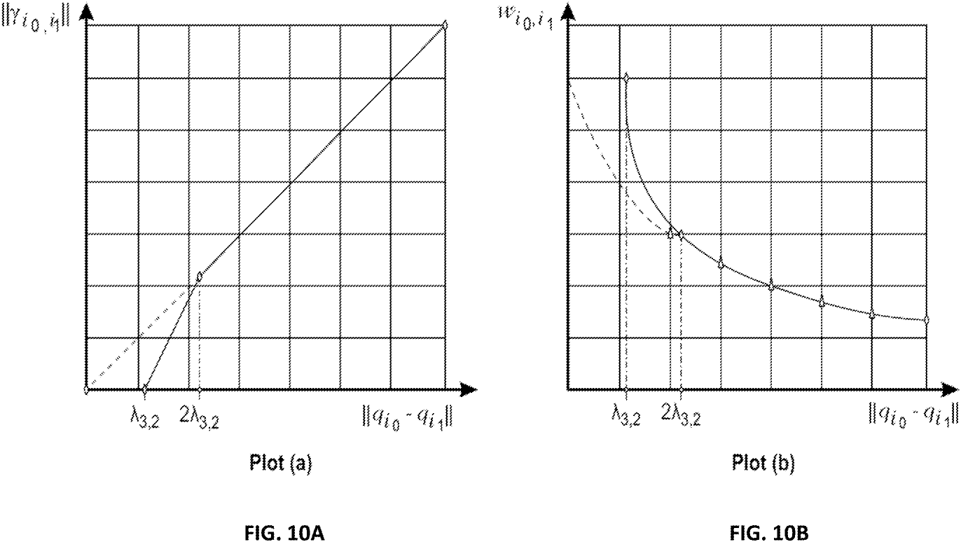

FIGS. 10A and 10B are a diagrams illustrating example plots of variables for mouth or eye adjustment. The system 100 may use a distance constraint via a predetermined graph or scale to control or adjust the mouth expression on a more sensitive or fine-tuned basis. For example, given parameters (λ_{3,0},λ_{3,1},λ_{3,2}), the distance constraint may be modified as Equation (46), where the weight w_{i0,i1} is defined in Equation (27) and r_{i0,i1} is defined in Equation (47). FIGS. 10A and 10B depicts a plot of variables according to ||qi0 -qi1||: (a) || r_{i0,i1} ||, and (b) w_{i0,i1}. The two variables w_{i0,i1} and r_{i0,i1} are defined into three segments. The first segment is to enable zero distance constraint with the largest weight. The third segment is to maintain the original distance with the smallest weight. The second segment is to achieve a smooth transition between the first and the third segments. In some embodiments, setting λ_{3,2}=0 gives the simple distance constraint.

If the distance between the two 2D landmarks (i₀, i₁) is smaller than λ_{3,2}, the two projected 3D landmarks may coincide (as depicted by Plot (a)), and the weight w_{i0,i1} may reach the maximum value (as depicted by Plot (b)). This leads to the eye\mouth closing after optimization. As the distance between the two 2D landmarks (i₀, i₁) increases, the weight w_{i0,i1} reduces, and the projected 3D landmarks would separate, thereby leading to eye or mouth being in open position after optimization.

As such, the expression optimization in Equation (13) includes a landmark fitting term, a weighted distance constraint term, and a regularization term. The solution for Equation (13) may described by Equation (30). With notations in Equation (21), Equation (4) may be described as Equation (48). With notations in Equation (25), Equation (26) and Equation (29), the landmark fitting term may be described by Equation (49). With notations in Equation (27) and Equation (29), the weighted distance term may be described by Equation (50). Combining with expression regularization, the expression optimization can be rewritten as Equation (51). Substituting Equation (28) into Equation (51) gives Equation (30).

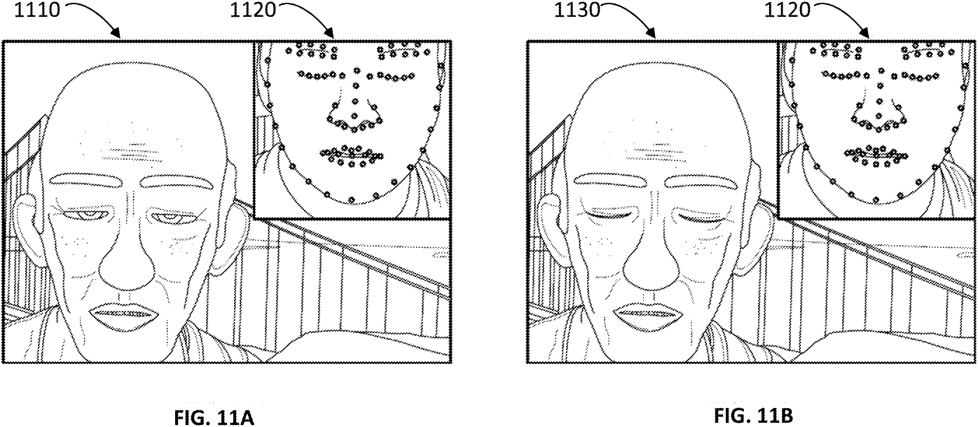

FIGS. 11A and 11B are diagrams illustrating an example of different avatar rendering results with and without modified distance constraints being applied. FIG. 11A depicts the rendered avatar 1110 for image 1120 without distance constraints being applied. FIG. 11B depicts the rendered avatar 1130 for image 1120 with modified distance constraints being applied.

The 3DMM parameters in Equation (33) provide for the optimized fitting result to the augmented 2D landmarks in Equation (32). Substituting Equation (1) into Equation (2), a projection matrix may be described by Equation (52). The original image and the augmented image are of the same identity and the same expression. The 3D facial landmarks are described by Fᵢ=mᵢ +Xᵢx + Yᵢy. According to the definition, the best fitting of all 2D landmarks {qᵢ} are the first two dimensions of the transformed landmarks in the 3D viewport as described by Equation (53). Accordingly, the best fitting of all 2D landmarks in Equation (32) are the first two dimensions of the transformed landmarks in the 3D viewport as described by Equation (54). Combing with Equation (55), the projection matrix for the augmented image may be described by Equation (56) which equals to substituting Equation (33) into Equation (2).

The system 100 may perform a pose conversion from a video frame. The pose in Equation (36) is based on image size h×h. The projection matrix by substituting Equation (36) into Equation (2) and may not be used for rendering the avatar to the original video frame. Taking Equation (35) and Equation (37) into account, the correct projection matrix for the original video frame is illustrated by Equation (57), which is equivalent to substitute Equation (38) into Equation (2). Thus, Equation (38) describes the 3DMM parameters for the video frame.

FIGS. 12A - 12C are diagrams illustrating examples of three different customizations for expression retargeting. As discussed above, the system 100 may perform expression retargeting from a user image to an avatar. In some embodiments, the system 100 may adjust one or more pose values and/or facial expression parameter values generated by the trained ML network 516. The system 100 may applying a function to adjust one or more facial expression parameter values to increase or decrease the intensity of the facial expression of the avatar.

In some embodiments, the digital representation of a rendered avatar may be depicted as having a mouth being opened more, or being opened less than as actually depicted in an image where the facial expression parameters values for the mouth expression values were derived. In another example, the digital representation of a rendered avatar may be depicted as having an eyelid being opened more, or being opened less than as actually depicted in an image where the facial expression parameters values for the eyelid facial expression values were derived.

Referring back to FIGS. 12A - 12C, the diagrams illustrate different cases of applying a mapping function to the facial expression parameters generated by the ML Network 516. The different cases include using four segment mapping (FIG. 12A), two segment mapping (FIG. 12B), and direct mapping (FIG. 12C). The system 100 may use the mapping functions to retarget expressions of a user. For example, referring to FIG. 12A, mapping functions may be used to retarget eye blink expressions. The parameters (a,b,c,d), satisfying 0<a<b<c<1, 0<d<1, may be configured such that the four segments serve different purposes. The system 100 may use the first segment to remove the small vibration of the eyelid when the eyes are open. The system 100 may be configured in a manner to avoid smoothing eye blink expressions. In such a case, small differences in the tracked eye blink expressions between two neighboring frames may occur. The first segment would provide for a stable eyelid in the rendered avatar. The system 100 may determine that the movement distance of an eyelid or mouth of a video conference participant is below a predetermined threshold value. In such instances, the system 100, may not render the eyelid movement or mouth movement that are determined to be below the predetermined threshold distance value.

The system 100 may use the second segment to compensate for optimization errors for eyes. The optimization process may not be able to differentiate between a user with a larger eye closing by half and a user with a smaller eye closing the eye be half. In some cases, the optimization process 560 presented may generate a large eye blink expression for a user with a smaller eye. As a result, the avatar’s eyes may inadvertently be maintained in half closed position. This second segment would compensate for this situation. The system 100 may use the third segment to achieve a smooth transition between the second segment and the fourth segment. The system 100 may use the fourth segment to increase the sensitivity of the eye blink expression. This segment forces closing the avatar’s eye when the user’s eye blink expression (i.e., facial expression value) is close to 1. The setup in mapping function FIG. 12B may be used to increase the sensitivity of some expressions, such as a smile, mouth left and right, and brow expressions. For the remaining facial expressions, the setup in mapping function FIG. 12C may be used.

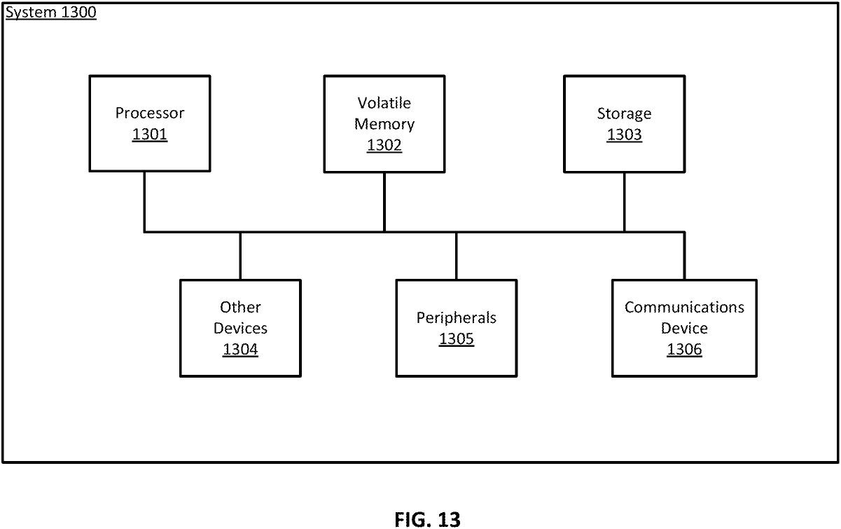

FIG. 13 is a diagram illustrating an exemplary computer that may perform processing in some embodiments. Exemplary computer 1300 may perform operations consistent with some embodiments. The architecture of computer 1300 is exemplary. Computers can be implemented in a variety of other ways. A wide variety of computers can be used in accordance with the embodiments herein.

Processor 1301 may perform computing functions such as running computer programs. The volatile memory 1302 may provide temporary storage of data for the processor 1301. RAM is one kind of volatile memory. Volatile memory typically requires power to maintain its stored information. Storage 1303 provides computer storage for data, instructions, and/or arbitrary information. Non-volatile memory, which can preserve data even when not powered and including disks and flash memory, is an example of storage. Storage 1303 may be organized as a file system, database, or in other ways. Data, instructions, and information may be loaded from storage 1303 into volatile memory 1302 for processing by the processor 1301.

The computer 1300 may include peripherals 1305. Peripherals 1305 may include input peripherals such as a keyboard, mouse, trackball, video camera, microphone, and other input devices. Peripherals 1305 may also include output devices such as a display. Peripherals 1305 may include removable media devices such as CD-R and DVD-R recorders/players. Communications device 1306 may connect the computer 1300 to an external medium. For example, communications device 1306 may take the form of a network adapter that provides communications to a network. A computer 1300 may also include a variety of other devices 1304. The various components of the computer 1300 may be connected by a connection medium such as a bus, crossbar, or network.

It will be appreciated that the present disclosure may include any one and up to all of the following examples.

Example 1: A computer-implemented method comprising: receiving a first video stream comprising multiple image frames of a video conference participant; inputting at least a group of pixels of each of the multiple image frames into a trained machine learning network; generating by the trained machine learning network, a plurality of facial expression parameter values associated with the multiple image frames; modifying one or more of the plurality of facial expression parameter values to generate one or more modified facial expression parameter values; generating a second video stream by: based on the one or more modified facial expression parameter values, morphing a three-dimensional head mesh of an avatar model; and rendering a digital representation of the video conference participant in an avatar form; and providing for display, in a user interface, the second video stream.

Example 2. The computer-implemented method of Example 1, wherein modifying the one or more of the plurality of facial expression parameter values comprises: adjusting one or more of the plurality of facial expression parameter values such that the digital representation displays a mouth, or an eyelid depicted as being opened more or being opened less than as depicted in an image from which the one or more facial expression parameters values were derived.

Example 3. The computer-implemented method of any one of Examples 1-2, wherein modifying one or more of the plurality of facial expression parameter values comprises: determining that a movement distance of an eyelid depicted in a first image as compared to a second image is below a predetermined threshold distance value; and omitting the rendering of an eyelid facial expression where the movement distance of the eyelid is determined to be below the predetermined threshold distance value.

Example 4. The computer-implemented method of any one of Examples 1-3, wherein modifying one or more of the plurality of facial expression parameter values comprises: adjusting one or more of the of the plurality of facial expression parameter values to increase or decrease the intensity of a depicted facial expression of the digital representation.

Example 5. The computer-implemented method of any one of Examples 1-4, wherein modifying one or more of the plurality of facial expression parameter values comprises: smoothing one or more of the of the plurality of facial expression parameter values to reduce a change in intensity from a first intensity level of a facial expression depicted in a first image to a second intensity level of the facial expression depicted in a second image.

Example 6. The computer-implemented method of any one of Examples 1-5, further comprising the operations of: performing an optimization process on a set of labeled training images to optimize facial expression parameters; augmenting the labeled training images with the optimized facial expression parameters; and training the machine learning network with the augmented training images.

Example 7. The computer-implemented method of any one of Examples 1-6, wherein the optimized facial expression parameters comprise at least a pose optimized values, identity optimized values, facial expression optimized values, or a combination thereof.

Example 8. A non-transitory computer readable medium that stores executable program instructions that when executed by one or more computing devices configure the one or more computing devices to perform operations comprising: receiving a first video stream comprising multiple image frames of a video conference participant; inputting at least a group of pixels of each of the multiple image frames into a trained machine learning network; generating by the trained machine learning network, a plurality of facial expression parameter values associated with the multiple image frames; modifying one or more of the plurality of facial expression parameter values to generate one or more modified facial expression parameter values; generating a second video stream by: based on the one or more modified facial expression parameter values, morphing a three-dimensional head mesh of an avatar model; and rendering a digital representation of the video conference participant in an avatar form; and providing for display, in a user interface, the second video stream.

Example 9. The non-transitory computer readable medium of Example 8, wherein the operation of modifying one or more of the plurality of facial expression parameter values comprises: adjusting one or more of the plurality of facial expression parameter values such that the digital representation displays a mouth, or an eyelid depicted as being opened more or being opened less than as depicted in an image from which the one or more facial expression parameters values were derived.

Example 10. The non-transitory computer readable medium of any one of Examples 8-9, wherein the operation of modifying one or more of the plurality of facial expression parameter values comprises: determining that a movement distance of an eyelid depicted in a first image as compared to a second image is below a predetermined threshold distance value; and omitting the rendering of an eyelid facial expression where the movement distance of the eyelid is determined to be below the predetermined threshold distance value.

Example 11. The non-transitory computer readable medium of any one of Examples 8-10, wherein the operation of modifying one or more of the plurality of facial expression parameter values comprises: adjusting one or more of the of the plurality of facial expression parameter values to increase or decrease the intensity of a depicted facial expression of the digital representation.

Example 12. The non-transitory computer readable medium of any one of Examples 8-11, further comprising the operation of: smoothing one or more of the of the plurality of facial expression parameter values to reduce a change in intensity from a first intensity level of a facial expression depicted in a first image to a second intensity level of the facial expression depicted in a second image.

Example 13. The non-transitory computer readable medium of any one of Examples 8-12, further comprising the operation of: performing an optimization process on a set of labeled training images to optimize facial expression parameters; augmenting the labeled training images with the optimized facial expression parameters; and training the machine learning network with the augmented training images.

Example 14. The non-transitory computer readable medium of any one of Examples 8-13, wherein the optimized facial expression parameters comprise at least a pose optimized values, identity optimized values, facial expression optimized values, or a combination thereof.

Example 15. A system comprising one or more processors configured to perform the operations of: receiving a first video stream comprising multiple image frames of a video conference participant; inputting at least a group of pixels of each of the multiple image frames into a trained machine learning network; generating by the trained machine learning network, a plurality of facial expression parameter values associated with the multiple image frames; modifying one or more of the plurality of facial expression parameter values to generate one or more modified facial expression parameter values; generating a second video stream by: based on the one or more modified facial expression parameter values, morphing a three-dimensional head mesh of an avatar model; and rendering a digital representation of the video conference participant in an avatar form; and providing for display, in a user interface, the second video stream.

Example 16. The system of Example 15, wherein modifying the one or more of the plurality of facial expression parameter values comprises: adjusting one or more of the plurality of facial expression parameter values such that the digital representation displays a mouth, or an eyelid depicted as being opened more or being opened less than as depicted in an image from which the one or more facial expression parameters values were derived.

Example 17. The system of any one of Examples 15-16, wherein modifying one or more of the plurality of facial expression parameter values comprises: determining that a movement distance of an eyelid depicted in a first image as compared to a second image is below a predetermined threshold distance value; and omitting the rendering of an eyelid facial expression where the movement distance of the eyelid is determined to be below the predetermined threshold distance value.

Example 18. The system of any one of Examples 15-17, wherein modifying one or more of the plurality of facial expression parameter values comprises: adjusting one or more of the of the plurality of facial expression parameter values to increase or decrease the intensity of a depicted facial expression of the digital representation.

Example 19. The system of any one of Examples 15-18, wherein modifying one or more of the plurality of facial expression parameter values comprises: smoothing one or more of the of the plurality of facial expression parameter values to reduce a change in intensity from a first intensity level of a facial expression depicted in a first image to a second intensity level of the facial expression depicted in a second image.

Example 20. The system of any one of Examples 15-19, further comprising the operations of: performing an optimization process on a set of labeled training images to optimize facial expression parameters; augmenting the labeled training images with the optimized facial expression parameters; and training the machine learning network with the augmented training images.

Example 21. The system of any one of Examples 15-20, wherein the optimized facial expression parameters comprise at least a pose optimized values, identity optimized values, facial expression optimized values, or a combination thereof.

Some portions of the preceding detailed descriptions have been presented in terms of algorithms, equations and/or symbolic representations of operations on data bits within a computer memory. These algorithmic and/or equation descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general-purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A computer-implemented method comprising:
receiving a first video stream comprising multiple image frames of a video conference participant;
inputting at least a group of pixels of each of the multiple image frames into a trained machine learning network;
generating by the trained machine learning network, a plurality of facial expression parameter values associated with the multiple image frames;
modifying one or more of the plurality of facial expression parameter values to generate one or more modified facial expression parameter values;
generating a second video stream by:
based on the one or more modified facial expression parameter values, morphing a three-dimensional head mesh of an avatar model; and
rendering a digital representation of the video conference participant in an avatar form; and
providing for display, in a user interface, the second video stream.

2. The computer-implemented method of claim 1, wherein modifying the one or more of the plurality of facial expression parameter values comprises:
adjusting one or more of the plurality of facial expression parameter values such that the digital representation displays a mouth or an eyelid depicted as being opened more, or being opened less than as depicted in an image from which the one or more facial expression parameters values were derived.

3. The computer-implemented method of claim 1, wherein modifying one or more of the plurality of facial expression parameter values comprises:
determining that a movement distance of an eyelid depicted in a first image as compared to a second image is below a predetermined threshold distance value; and
omitting the rendering of an eyelid facial expression where the movement distance of the eyelid is determined to be below the predetermined threshold distance value.

4. The computer-implemented method of claim 1, wherein modifying one or more of the plurality of facial expression parameter values comprises:
adjusting one or more of the of the plurality of facial expression parameter values to increase or decrease the intensity of a depicted facial expression of the digital representation.

5. The computer-implemented method of claim 1, wherein modifying one or more of the plurality of facial expression parameter values comprises:
smoothing one or more of the of the plurality of facial expression parameter values to reduce a change in intensity from a first intensity level of a facial expression depicted in a first image to a second intensity level of the facial expression depicted in a second image.

6. The computer-implemented method of claim 1, further comprising the operations of:
performing an optimization process on a set of labeled training images to optimize facial expression parameters;
augmenting the labeled training images with the optimized facial expression parameters; and
training the machine learning network with the augmented training images.

7. The computer-implemented method of claim 6, wherein the optimized facial expression parameters comprise at least a pose optimized values, identity optimized values, facial expression optimized values, or a combination thereof.

8. A non-transitory computer readable medium that stores executable program instructions that when executed by one or more computing devices configure the one or more computing devices to perform operations comprising:
receiving a first video stream comprising multiple image frames of a video conference participant;
inputting at least a group of pixels of each of the multiple image frames into a trained machine learning network;
generating by the trained machine learning network, a plurality of facial expression parameter values associated with the multiple image frames;
modifying one or more of the plurality of facial expression parameter values to generate one or more modified facial expression parameter values;
generating a second video stream by:
based on the one or more modified facial expression parameter values, morphing a three-dimensional head mesh of an avatar model; and
rendering a digital representation of the video conference participant in an avatar form; and
providing for display, in a user interface, the second video stream.

9. The non-transitory computer readable medium of claim 8, wherein the operation of modifying one or more of the plurality of facial expression parameter values comprises:
adjusting one or more of the plurality of facial expression parameter values such that the digital representation displays a mouth or an eyelid depicted as being opened more, or being opened less than as depicted in an image from which the one or more facial expression parameters values were derived.

10. The non-transitory computer readable medium of claim 8, wherein the operation of modifying one or more of the plurality of facial expression parameter values comprises:
determining that a movement distance of an eyelid depicted in a first image as compared to a second image is below a predetermined threshold distance value; and
omitting the rendering of an eyelid facial expression where the movement distance of the eyelid is determined to be below the predetermined threshold distance value.

11. The non-transitory computer readable medium of claim 8, wherein the operation of modifying one or more of the plurality of facial expression parameter values comprises:
adjusting one or more of the of the plurality of facial expression parameter values to increase or decrease the intensity of a depicted facial expression of the digital representation.

12. The non-transitory computer readable medium of claim 8, further comprising the operation of:
smoothing one or more of the of the plurality of facial expression parameter values to reduce a change in intensity from a first intensity level of a facial expression depicted in a first image to a second intensity level of the facial expression depicted in a second image.

13. The non-transitory computer readable medium of claim 8, further comprising the operation of:
performing an optimization process on a set of labeled training images to optimize facial expression parameters;
augmenting the labeled training images with the optimized facial expression parameters; and
training the machine learning network with the augmented training images.

14. The non-transitory computer readable medium of claim 13, wherein the optimized facial expression parameters comprise at least a pose optimized values, identity optimized values, facial expression optimized values, or a combination thereof.

15. A system comprising one or more processors configured to perform the operations of:
receiving a first video stream comprising multiple image frames of a video conference participant;
inputting at least a group of pixels of each of the multiple image frames into a trained machine learning network;
generating by the trained machine learning network, a plurality of facial expression parameter values associated with the multiple image frames;
modifying one or more of the plurality of facial expression parameter values to generate one or more modified facial expression parameter values;
generating a second video stream by:
based on the one or more modified facial expression parameter values, morphing a three-dimensional head mesh of an avatar model; and
rendering a digital representation of the video conference participant in an avatar form; and
providing for display, in a user interface, the second video stream.

16. The system of claim 15, wherein modifying the one or more of the plurality of facial expression parameter values comprises:
adjusting one or more of the plurality of facial expression parameter values such that the digital representation displays a mouth or an eyelid depicted as being opened more, or being opened less than as depicted in an image from which the one or more facial expression parameters values were derived.

17. The system of claim 15, wherein modifying one or more of the plurality of facial expression parameter values comprises:
determining that a movement distance of an eyelid depicted in a first image as compared to a second image is below a predetermined threshold distance value; and
omitting the rendering of an eyelid facial expression where the movement distance of the eyelid is determined to be below the predetermined threshold distance value.

18. The system of claim 15, wherein modifying one or more of the plurality of facial expression parameter values comprises:
adjusting one or more of the of the plurality of facial expression parameter values to increase or decrease the intensity of a depicted facial expression of the digital representation.

19. The system of claim 15, wherein modifying one or more of the plurality of facial expression parameter values comprises:
smoothing one or more of the of the plurality of facial expression parameter values to reduce a change in intensity from a first intensity level of a facial expression depicted in a first image to a second intensity level of the facial expression depicted in a second image.

20. The system of claim 15, further comprising the operations of:
performing an optimization process on a set of labeled training images to optimize facial expression parameters;
augmenting the labeled training images with the optimized facial expression parameters; and
training the machine learning network with the augmented training images.
